(19) United States
(12) Patent Application Publication
(10) Pub. No.: US 2023/0307810 A1
(43) Pub. Date: Sep. 28, 2023

(54) FILTER AND ANTENNA COMPOSITE COMPONENT

(71) Applicant: TDK CORPORATION, Tokyo (JP)

(72) Inventors: Yuta ASHIDA, Tokyo (JP); Masahiro TATEMATSU, Tokyo (JP); Shuhei SAWAGUCHI, Tokyo (JP); Kenichi TEZUKA, Tokyo (JP); Aozora KAWASAKI, Tokyo (JP); Tetsuzo GOTO, Tokyo (JP); Tomoyuki GOI, Tokyo (JP)

(73) Assignee: TDK CORPORATION, Tokyo (JP)

(21) Appl. No.: 18/189,417

(22) Filed: Mar. 24, 2023

(30) Foreign Application Priority Data
Mar. 28, 2022 (JP) 2022-052303

(51) Int. Cl. H01P 1/20

(52) U.S. Cl. CPC H01P 1/20; H01P 7/06

(57) ABSTRACT

A filter includes a first port, a second port, a path, a circuit part, and at least one cavity resonator. The path connects the first port and the second port. The circuit part is provided in the path. Each of the at least one cavity resonator is coupled with the path from an outside of the path in a circuit configuration. The first cavity resonator is coupled with the path between the first port and the circuit part. The second cavity resonator is coupled with the path between the second port and the circuit part.

### CROSS REFERENCE TO RELATED APPLICATIONS

This application claims the benefit of Japanese Priority Patent Application No. 2022-052303 filed on Mar. 28, 2022, the entire contents of which are incorporated herein by reference.

### BACKGROUND OF THE INVENTION

### 1. Field of the Invention

The present invention relates to a filter including a cavity resonator and an antenna composite component including the filter.

### 2. Description of the Related Art

One of electronic components used in communication apparatuses is a band-pass filter. Such a band-pass filter is desired to reduce insertion loss in the passband thereof and increase insertion loss outside the passband.

US 2020/0303798 A1 describes a filter device configured by combining a band-pass filter and a band elimination filter (band stop filter). This filter device uses the band stop filter to increase insertion loss in a frequency region higher than the passband thereof.

US 2020/0021030 A1 describes a filter resonator including sidewalls formed of a conductive material and a dielectric layer.

Communication services using fifth-generation mobile communication systems (hereinafter referred to as 5G) are currently started to be provided. For 5G, the use of frequency bands of 10 GHz or higher, particularly a quasi-millimeter wave band of 10 to 30 GHz and a millimeter wave band of 30 to 300 GHz, is assumed. In these frequency bands, as the frequency bands used for fourth-generation or earlier mobile communication systems, a plurality of standards dealing with relatively close frequency bands are present. Hence, it is also desired, in a band-pass filter used in 5G, that insertion loss abruptly changes in a frequency region close to the passband of the band-pass filter.

Now, consider that a band-pass filter uses a band elimination filter to obtain characteristics of abrupt change of insertion loss in a frequency region close to the passband of the band-pass filter. In this case, the center frequency of the stop band of the band elimination filter need be set to a frequency close to the passband. However, there occurs a problem that the insertion loss of the passband of the band-pass filter increases.

A so-called cavity resonator as that described in US 2020/0021030 A1 can increase the Q value. In view of this, it is conceivable to use a cavity resonator to configure a band elimination filter. Also when a cavity resonator is used, it is still necessary to suppress an increase of the insertion loss of the passband of a band-pass filter. To enable this, it is necessary to provide a means for appropriately adjusting an influence of the cavity resonator on the pass attenuation characteristics of the band-pass filter. However, such a means has not sufficiently been studied heretofore.

### SUMMARY OF THE INVENTION

An object of the present invention is to provide a filter for which an influence of a cavity resonator on the characteristics of the entire filter can be adjusted, and an antenna composite component.

A filter of the present invention includes a first port, a second port, a path connecting the first port and the second port, a circuit part provided in the path, and at least one cavity resonator coupled with the path from an outside of the path in a circuit configuration.

In the filter of the present invention, the at least one cavity resonator may be composed of a conductor surrounding a three-dimensional region, and a dielectric present in the region.

In the filter of the present invention, the at least one cavity resonator may configure a band elimination filter.

In the filter of the present invention, the path may include a conductor part arranged in the at least one cavity resonator and extending in one direction. The conductor part may be located at a position shifted from the center of gravity of the at least one cavity resonator seen in one direction. The at least one cavity resonator may be coupled with the conductor part.

In the filter of the present invention, the at least one cavity resonator may include a plurality of cavity resonators. The plurality of cavity resonators may include a first cavity resonator coupled with the path between the first port and the circuit part, and a second cavity resonator coupled with the path between the second port and the circuit part.

In the filter of the present invention, the circuit part may be a band-pass filter. Alternatively, the circuit part may be a line.

The filter of the present invention may further include a main body for integrating the first port, the second port, the path, the circuit part, and the at least one cavity resonator. The main body may include a first surface and a second surface facing opposite to each other. In this case, the size of the at least one cavity resonator in a direction perpendicular to the first surface may be smaller than the size of the at least one cavity resonator in a direction parallel to the first surface.

In a case where the main body includes the first surface and the second surface, the first port may be arranged on the first surface, and the second port may be arranged at a position different from the first surface in the direction perpendicular to the first surface. Alternatively, the first port and the second port may be arranged on the first surface.

An antenna composite component of the present invention includes the filter of the present invention and an antenna connected to the second port.

In the filter and the antenna composite component of the present invention, the at least one cavity resonator is coupled with the path from the outside of the path connecting the first port and the second port, in a circuit configuration. With these, according to the present invention, it is possible to provide a filter for which an influence of a cavity resonator on the characteristics of the entire filter can be adjusted.

Other and further objects, features, and advantages of the present invention will appear more fully from the following description.

### BRIEF DESCRIPTION OF THE DRAWINGS

FIG. 1 is a circuit diagram illustrating a circuit configuration of a filter according to a first embodiment of the present invention.

FIG. 2 is an explanatory diagram illustrating a patterned surface of a first dielectric layer in a main body of the filter according to the first embodiment of the present invention.

FIG. 3 is an explanatory diagram illustrating a patterned surface of a second dielectric layer in the main body of the filter according to the first embodiment of the present invention.

FIG. 4 is an explanatory diagram illustrating a patterned surface of each of a third to a ninth dielectric layer in the main body of the filter according to the first embodiment of the present invention.

FIG. 5 is an explanatory diagram illustrating a patterned surface of a tenth dielectric layer in the main body of the filter according to the first embodiment of the present invention.

FIG. 6 is an explanatory diagram illustrating a patterned surface of an eleventh dielectric layer in the main body of the filter according to the first embodiment of the present invention.

FIG. 7 is an explanatory diagram illustrating a patterned surface of each of a twelfth to a seventeenth dielectric layer in the main body of the filter according to the first embodiment of the present invention.

FIG. 8 is an explanatory diagram illustrating a terminal-formed surface of an eighteenth dielectric layer in the main body of the filter according to the first embodiment of the present invention.

FIG. 9 is a perspective view illustrating an appearance of the filter according to the first embodiment of the present invention.

FIG. 10 is a perspective view illustrating inside of the main body of the filter according to the first embodiment of the present invention.

FIG. 11 is a plan view illustrating inside of the main body of the filter according to the first embodiment of the present invention.

FIG. 12 is a characteristic diagram illustrating an example of a frequency response of the filter according to the first embodiment of the present invention.

FIG. 13 is a characteristic diagram illustrating part of the frequency response illustrated in FIG. 11, in an enlarged manner.

FIG. 14 is a circuit diagram illustrating a circuit configuration of an antenna composite component according to a second embodiment of the present invention.

FIG. 15 is an explanatory diagram illustrating a patterned surface of a first dielectric layer in a main body of the antenna composite component according to the second embodiment of the present invention.

FIG. 16 is an explanatory diagram illustrating a patterned surface of a second dielectric layer in the main body of the antenna composite component according to the second embodiment of the present invention.

FIG. 17 is an explanatory diagram illustrating a patterned surface of each of a third to an eighth dielectric layer in the main body of the antenna composite component according to the second embodiment of the present invention.

FIG. 18 is an explanatory diagram illustrating a patterned surface of a ninth dielectric layer in the main body of the antenna composite component according to the second embodiment of the present invention.

FIG. 19 is an explanatory diagram illustrating a patterned surface of a tenth dielectric layer in the main body of the antenna composite component according to the second embodiment of the present invention.

FIG. 20 is an explanatory diagram illustrating a patterned surface of an eleventh dielectric layer in the main body of the antenna composite component according to the second embodiment of the present invention.

FIG. 21 is an explanatory diagram illustrating a patterned surface of each of a twelfth to a seventeenth dielectric layer in the main body of the antenna composite component according to the second embodiment of the present invention.

FIG. 22 is an explanatory diagram illustrating a patterned surface of an eighteenth dielectric layer in the main body of the antenna composite component according to the second embodiment of the present invention.

FIG. 23 is an explanatory diagram illustrating a patterned surface of each of a nineteenth to a twentieth dielectric layer in the main body of the antenna composite component according to the second embodiment of the present invention.

FIG. 24 is an explanatory diagram illustrating a patterned surface of a twenty-first dielectric layer in the main body of the antenna composite component according to the second embodiment of the present invention.

FIG. 25 is an explanatory diagram illustrating a patterned surface of each of a twenty-second and a twenty-third dielectric layer in the main body of the antenna composite component according to the second embodiment of the present invention.

FIG. 26 is an explanatory diagram illustrating a patterned surface of a twenty-fourth dielectric layer in the main body of the antenna composite component according to the second embodiment of the present invention.

FIG. 27 is an explanatory diagram illustrating a patterned surface of each of a twenty-fifth to a thirty-second dielectric layer in the main body of the antenna composite component according to the second embodiment of the present invention.

FIG. 28 is an explanatory diagram illustrating a patterned surface of a thirty-third dielectric layer in the main body of the antenna composite component according to the second embodiment of the present invention.

FIG. 29 is an explanatory diagram illustrating a patterned surface of a thirty-fourth dielectric layer in the main body of the antenna composite component according to the second embodiment of the present invention.

FIG. 30 is an explanatory diagram illustrating a patterned surface of a thirty-fifth dielectric layer in the main body of the antenna composite component according to the second embodiment of the present invention.

FIG. 31 is an explanatory diagram illustrating a patterned surface of each of a thirty-sixth to a fifty-fourth dielectric layer in the main body of the antenna composite component according to the second embodiment of the present invention.

FIG. 32 is an explanatory diagram illustrating a patterned surface of a fifty-fifth dielectric layer in the main body of the antenna composite component according to the second embodiment of the present invention.

FIG. 33 is a perspective view illustrating an appearance of the antenna composite component according to the second embodiment of the present invention.

FIG. 34 is a perspective view illustrating inside of a first portion of the main body of the antenna composite component according to the second embodiment of the present invention.

FIG. 35 is a plan view illustrating inside of a second portion of the main body of the antenna composite component according to the second embodiment of the present invention.

FIG. 36 is a plan view illustrating inside of the first portion of the main body of the antenna composite component according to the second embodiment of the present invention.

FIG. 37 is a circuit diagram illustrating a circuit configuration of an antenna composite component according to a third embodiment of the present invention.

FIG. 38 is an explanatory diagram illustrating a patterned surface of a second dielectric layer in a main body of the antenna composite component according to the third embodiment of the present invention.

FIG. 39 is an explanatory diagram illustrating a patterned surface of each of a third to a ninth dielectric layer in the main body of the antenna composite component according to the third embodiment of the present invention.

FIG. 40 is an explanatory diagram illustrating a patterned surface of a tenth dielectric layer in the main body of the antenna composite component according to the third embodiment of the present invention.

FIG. 41 is an explanatory diagram illustrating a patterned surface of each of an eleventh to a seventeenth dielectric layer in the main body of the antenna composite component according to the third embodiment of the present invention.

FIG. 42 is a perspective view illustrating inside of a first portion of the main body of the antenna composite component according to the third embodiment of the present invention.

### DETAILED DESCRIPTION OF THE PREFERRED EMBODIMENTS

### First Embodiment

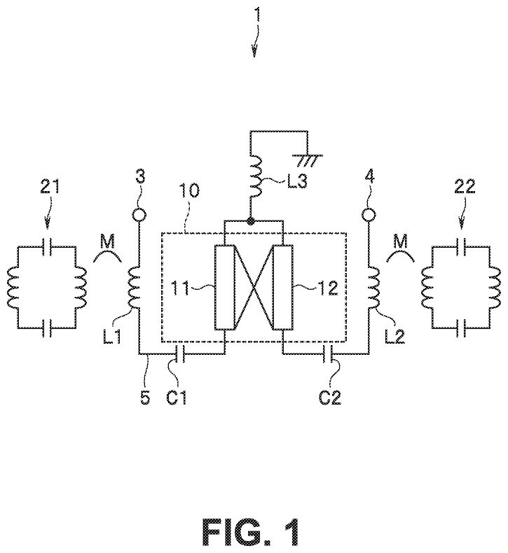

Preferred embodiments of the present invention will now be described in detail with reference to the drawings. First, reference is made to FIG. 1 to describe an overview of a configuration of a filter 1 according to a first embodiment of the present invention. FIG. 1 is a circuit diagram illustrating a circuit configuration of the filter 1. The filter 1 includes a first port 3, a second port 4, a path 5 connecting the first port 3 and the second port 4, a circuit part 10 provided in the path 5, and at least one cavity resonator. Each of the first and second ports 3 and 4 is a port for input or output of a signal.

In the present embodiment, the circuit part 10 is a band-pass filter. The filter 1 as a whole functions as a band-pass filter.

The at least one cavity resonator is coupled with the path 5 from the outside of the path 5 in a circuit configuration. The at least one cavity resonator is not provided in the path 5 in the circuit configuration. Note that, as used herein, the phrase “in a circuit configuration” is to describe layout in a circuit diagram, not in a physical configuration. Hence, in a circuit diagram, as long as the at least one cavity resonator is coupled with the path 5 from the outside of the path 5, the path 5 may physically pass inside the at least one cavity resonator.

In the present embodiment, in particular, the at least one cavity resonator configures a band elimination filter. The at least one cavity resonator is a plurality of cavity resonators. In the example illustrated in FIG. 1, the plurality of cavity resonators include a cavity resonator 21 coupled with the path 5 between the first port 3 and the circuit part 10, and a cavity resonator 22 coupled with the path 5 between the second port 4 and the circuit part 10. In FIG. 1, each of the cavity resonators 21 and 22 is expressed as an equivalent circuit including two inductors and two capacitors.

Reference is now made to FIG. 1 to describe an example of a circuit configuration of the filter 1 and the circuit part 10. The circuit part 10 includes two resonators 11 and 12 arranged in this order, from closest to farthest, from the first port 3 in the circuit configuration. Each of the resonators 11 and 12 is a quarter-wave resonator with one end being short-circuited and the other end being open. The resonators 11 and 12 are magnetically coupled with each other.

One end of the resonator 11 is coupled with the first port 3. One end of the resonator 12 is coupled with the second port 4. The respective other ends of the resonators 11 and 12 are connected to the ground. In FIG. 1, the reference sign L3 denotes an inductance component of a line connecting the resonators 11, 12 and the ground.

The filter 1 further includes a capacitor C1 provided between the resonator 11 and the first port 3 in the circuit configuration, and a capacitor C2 provided between the resonator 12 and the second port 4 in the circuit configuration.

The path 5 includes conductor parts L1 and L2. The conductor part L1 is located between the first port 3 and the capacitor C1 in the circuit configuration. The conductor part L2 is located between the second port 4 and the capacitor C2 in the circuit configuration. The cavity resonators 21 and 22 are coupled with the conductor parts L1 and L2, respectively. In FIG. 1, two respective curved lines denoted by a sign M represent coupling between the cavity resonator 21 and the conductor part L1 and coupling between the cavity resonator 22 and the conductor part L2.

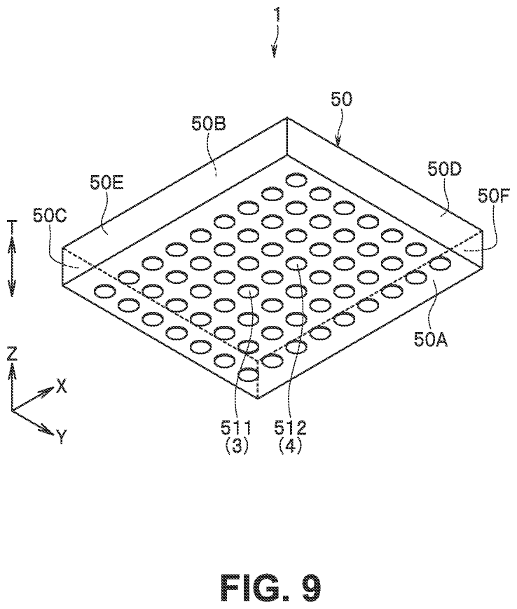

Next, a physical configuration of the filter 1 will be described. The filter 1 includes a main body 50 for integrating the components of the filter 1 described with reference to FIG. 1. The first port 3, the second port 4, the path 5, the circuit part 10, and the cavity resonators 21 and 22 are integrated into the main body 50. Note that the main body 50 is illustrated in FIG. 9 to be described later.

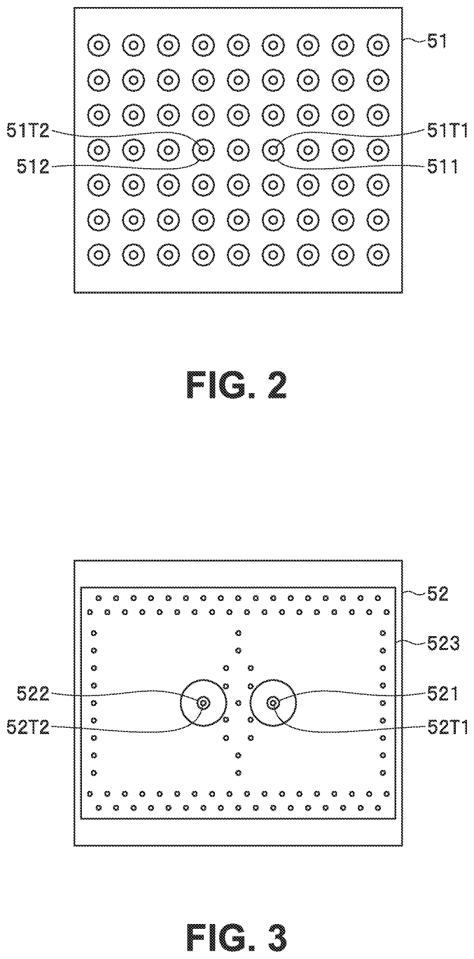

The main body 50 includes a plurality of dielectric layers stacked together and a plurality of conductor layers and a plurality of through holes formed in the plurality of dielectric layers. Reference is now made to FIG. 2 to FIG. 8 to describe the plurality of dielectric layers and the plurality of conductor layers constituting the main body 50. In the present embodiment, the main body 50 includes eighteen dielectric layers stacked together. The eighteen dielectric layers will be referred to as the first to eighteenth dielectric layers in the order from bottom to top. The first to eighteenth dielectric layers are denoted by reference numerals 51 to 68, respectively.

FIG. 2 illustrates a patterned surface of the first dielectric layer 51. A plurality of conductor layers are formed on the patterned surface of the dielectric layer 51. The plurality of dielectric layers include conductor layers 511 and 512. The plurality of through holes connected to the plurality of respective conductor layers are formed in the dielectric layer 51. The plurality of through holes include particular through holes 51T1 and 51T2 connected respectively to the conductor layers 511 and 512. In FIG. 2, a plurality of first circles and a plurality of second circles located inside the plurality of respective first circles are illustrated. Each first circle represents a conductor layer, and each second circle represents a through hole.

FIG. 3 illustrates a patterned surface of the second dielectric layer 52. Conductor layers 521, 522, and 523 are formed on the patterned surface of the dielectric layer 52. The particular through holes 51T1 and 51T2 formed in the dielectric layer 51 are connected respectively to the conductor layers 521 and 522. The plurality of through holes (excluding the particular through holes 51T1 and 51T2) formed in the dielectric layer 51 are connected to the conductor layer 523. The two particular through holes 52T1 and 52T2 connected respectively to the conductor layers 521 and 522 and the plurality of through holes connected to the conductor layer 523 are formed in the dielectric layer 52. In FIG. 3, each circle illustrated in the conductor layer 523 represents a through hole.

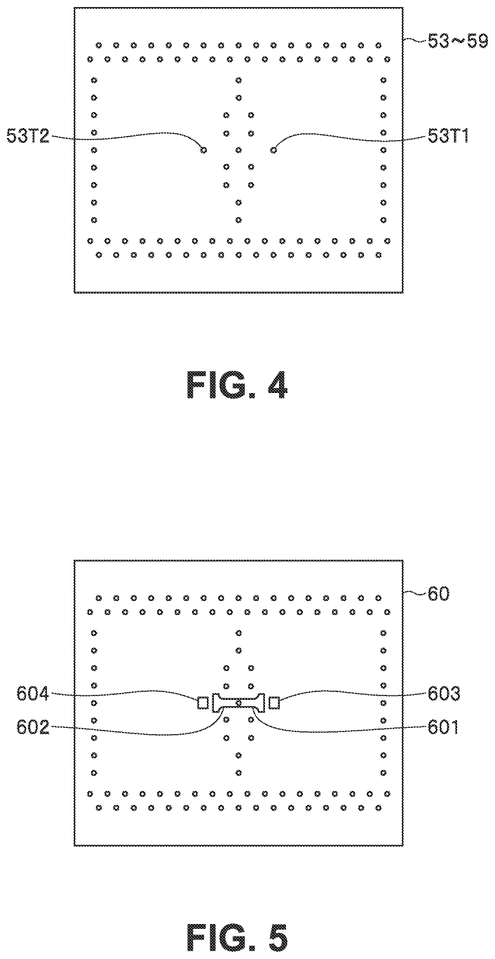

FIG. 4 illustrates a patterned surface of each of the third to ninth dielectric layers 53 to 59. A plurality of through holes are formed in each of the dielectric layers 53 to 59. The plurality of through holes include particular through holes 53T1 and 53T2 formed in each of the dielectric layers 53 to 59. The particular through holes 52T1 and 52T2 formed in the dielectric layer 52 are connected respectively to the particular through holes 53T1 and 53T2 formed in the dielectric layer 53. In FIG. 4, each circle represents a through hole. In the dielectric layers 53 to 59, every vertically adjacent through holes are connected to each other.

FIG. 5 illustrates a patterned surface of the tenth dielectric layer 60. Resonator conductor layers 601 and 602 and conductor layers 603 and 604 are formed on the patterned surface of the dielectric layer 60. Each of the conductor layers 601 and 602 has a first end and a second end located opposite to each other. The first end of the conductor layer 601 and the first end of the conductor layer 602 are connected to each other. The second end of the conductor layer 601 is at a predetermined distance from and adjacent to the conductor layer 603. The second end of the conductor layer 602 is at a predetermined distance from and adjacent to the conductor layer 604. The particular through holes 53T1 and 53T2 formed in the dielectric layer 59 are connected respectively to the conductor layers 603 and 604.

A plurality of through holes are formed in the dielectric layer 60. In FIG. 5, each circle represents a through hole.

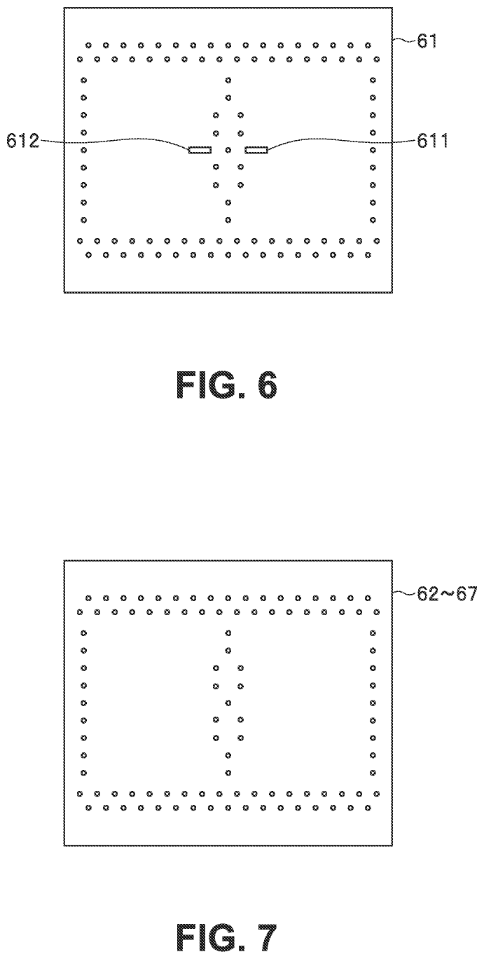

FIG. 6 illustrates a patterned surface of the eleventh dielectric layer 61. Conductor layers 611 and 612 are formed on the patterned surface of the dielectric layer 61. A plurality of through holes are formed in the dielectric layer 61. In FIG. 6, each circle represents a through hole.

FIG. 7 illustrates a patterned surface of each of the twelfth to seventeenth dielectric layers 62 to 67. A plurality of through holes are formed in each of the dielectric layers 62 to 67. In FIG. 7, each circle represents a through hole. In the dielectric layers 62 to 67, every vertically adjacent through holes are connected to each other.

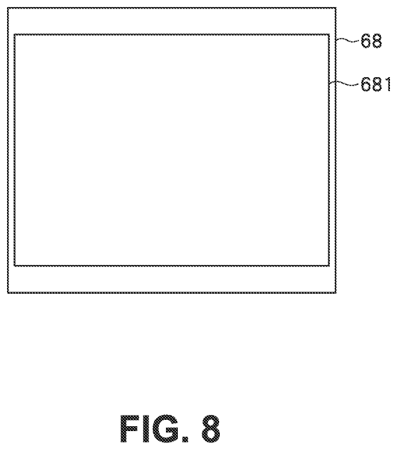

FIG. 8 illustrates a patterned surface of the eighteenth dielectric layer 68. A conductor layer 681 is formed on the patterned surface of the dielectric layer 68. The plurality of through holes formed in the dielectric layer 67 are connected to the conductor layer 681.

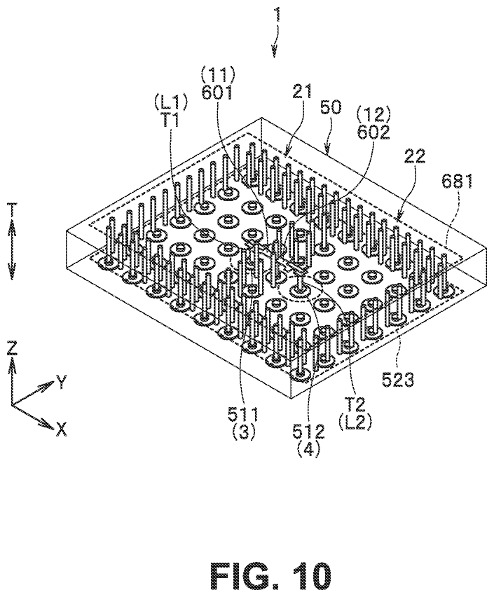

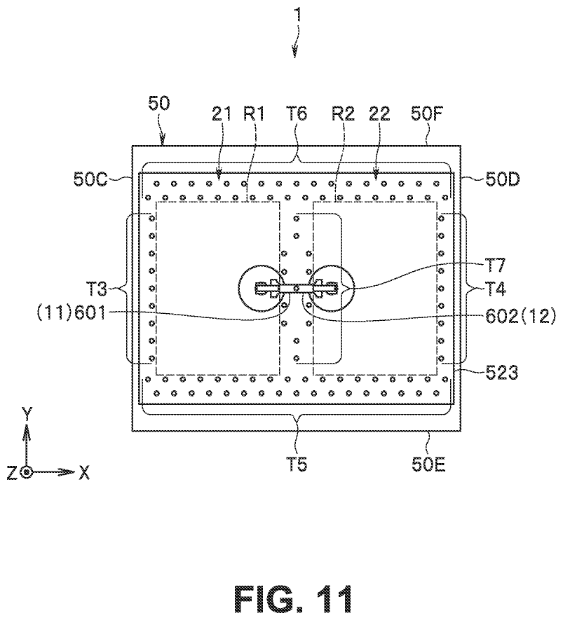

FIG. 9 illustrates the main body 50 formed by stacking the first to eighteenth dielectric layers 51 to 68. FIG. 10 and FIG. 11 illustrate inside of the main body 50. The main body 50 has a bottom surface 50A and a top surface 50B located at opposite ends of the plurality of dielectric layers in a stacking direction T, and four side surfaces 50C to 50F connecting the bottom surface 50A and the top surface 50B. The side surfaces 50C and 50D face opposite to each other, and also the side surfaces 50E and 50F face opposite to each other. The side surfaces 50C to 50F are perpendicular to the bottom surface 50A and the top surface 50B.

Here, X, Y, and Z directions are defined as illustrated in FIG. 9. The X, Y, and Z directions are orthogonal to one another. In the present embodiment, the Z direction is a direction parallel to the stacking direction T. The direction opposite to the X direction is −X direction, the direction opposite to the Y direction is −Y direction, and the direction opposite to the Z direction is −Z direction.

As illustrated in FIG. 9, the bottom surface 50A is located at a −Z-direction end of the main body 50. The top surface 50B is located at a Z-direction end of the main body 50. The side surface 50C is located at a −X-direction end of the main body 50. The side surface 50D is located at an X-direction end of the main body 50. The side surface 50E is located at a −Y-direction end of the main body 50. The side surface 50F is located at a Y-direction end of the main body 50.

The bottom surface 50A and the top surface 50B face opposite to each other. The bottom surface 50A corresponds to a “first surface” in the present invention. The top surface 50B corresponds to a “second surface” in the present invention.

The main body 50 is formed by stacking the first to eighteenth dielectric layers 51 to 68 such that the patterned surface of the first dielectric layer 51 also serves as the bottom surface 50A of the main body 50 and a surface opposite to the patterned surface of the eighteenth dielectric layer 68 also serves as the top surface 50B of the main body 50. As illustrated in FIG. 10, the plurality of conductor layers and the plurality of through holes illustrated in FIG. 2 to FIG. 8 are stacked inside the main body 50.

Each of the plurality of through holes illustrated in FIG. 2 to FIG. 7 excluding the above-described plurality of particular through holes is connected to the conductor layers overlapping the through hole in the stacking direction T or other through holes overlapping the through hole in the stacking direction T when the first to eighteenth dielectric layers 51 to 68 are stacked together.

Correspondences of the components of the filter 1 illustrated in FIG. 1 with the components in the main body 50 illustrated in FIG. 2 to FIG. 10 will now be described. The first port 3 is composed of the conductor layer 511. The second port 4 is composed of the conductor layer 512. In the present embodiment, the first port 3 and the second port 4 are both arranged on the bottom surface 50A of the main body 50.

The resonator 11 of the circuit part 10 is composed of the resonator conductor layer 601. The resonator 12 of the circuit part 10 is composed of the resonator conductor layer 602.

The capacitor C1 is formed of the resonator conductor layer 601, the conductor layers 603 and 611, and the dielectric layer 60 between these conductor layers. The capacitor C2 is formed of the resonator conductor layer 602, the conductor layers 604 and 612, and the dielectric layer 60 between these conductor layers.

The conductor part L1 of the path 5 is composed of the particular through holes 52T1 and 53T1. The conductor part L2 of the path 5 is composed of the particular through holes 52T2 and 53T2.

Here, a structure formed by connecting two or more through holes in series is referred to as a through hole line. The through hole line is a structure of a conductor extending in a direction parallel to the Z direction. The main body 50 includes through hole lines T1 and T2. The through hole line T1 is composed of the particular through holes 52T1 and 53T1. The through hole line T2 is composed of the particular through holes 52T2 and 53T2. The conductor part L1 of the path 5 is composed of the through hole line T1. The conductor part L2 of the path 5 is composed of the through hole line T2.

The main body 50 further includes a plurality of through hole lines T3, a plurality of through hole lines T4, a plurality of through hole lines T5, a plurality of through hole lines T6, and a plurality of through hole lines T7. As illustrated in FIG. 11, the plurality of through hole lines T3 are arranged to be aligned in a direction parallel to the Y direction near the side surface 50C. The plurality of through hole lines T4 are arranged to be aligned in a direction parallel to the Y direction near the side surface 50D. The plurality of through hole lines T5 are arranged to be aligned in a direction parallel to the X direction near the side surface 50E. The plurality of through hole lines T6 are arranged to be aligned in a direction parallel to the X direction near the side surface 50F. The plurality of through hole lines T7 are aligned in a direction parallel to the Y direction in a central portion of the main body 50 in a direction parallel to the X direction.

Each of the plurality of through hole lines T3, the plurality of through hole lines T4, the plurality of through hole lines T5, the plurality of through hole lines T6, and the plurality of through hole lines T7 connects the conductor layer 523 and the conductor layer 681. The plurality of through holes (excluding the particular through holes 51T1 and 51T2) formed in the dielectric layer 51 are connected to the conductor layer 523 and are also connected to the plurality of conductor layers (excluding the conductor layers 511 and 512) formed on the patterned surface of the dielectric layer 51. The plurality of conductor layers (excluding the conductor layers 511 and 512) formed on the patterned surface of the dielectric layer 51 are connected to the ground. Hence, the plurality of through hole lines T3, the plurality of through hole lines T4, the plurality of through hole lines T5, the plurality of through hole lines T6, the plurality of through hole lines T7, and the conductor layers 523 and 681 are connected to the ground. The plurality of through hole lines T7 includes the through hole lines connected to the resonator conductor layers 601 and 602.

As illustrated in FIG. 11, the plurality of through hole lines T3, the plurality of through hole lines T5, the plurality of through hole lines T6, the plurality of through hole lines T7, and the conductor layers 523 and 681 surround a three-dimensional region R1. The plurality of through hole lines T4, the plurality of through hole lines T5, the plurality of through hole lines T6, the plurality of through hole lines T7, and the conductor layers 523 and 681 surround a three-dimensional region R2.

In the region R1, a first dielectric is present. The first dielectric is composed of parts of the dielectric layers 52 to 67. In the region R2, a second dielectric is present. The second dielectric is composed of other parts of the dielectric layers 52 to 67.

The cavity resonator 21 is composed of a conductor surrounding the three-dimensional region R1 (the plurality of through hole lines T3, the plurality of through hole lines T5, the plurality of through hole lines T6, the plurality of through hole lines T7, and the conductor layers 523 and 681) and the first dielectric present in the region R1 (parts of the dielectric layers 52 to 67). The cavity resonator 22 is composed of a conductor surrounding the three-dimensional region R2 (the plurality of through hole lines T4, the plurality of through hole lines T5, the plurality of through hole lines T6, the plurality of through hole lines T7, and the conductor layers 523 and 681) and the second dielectric present in the region R2 (other parts of the dielectric layers 52 to 67).

Reference is now made to FIG. 2 to FIG. 11 to describe structural features of the filter 1 according to the present embodiment. The through hole line T1, i.e., the conductor part L1 of the path 5, is arranged in the cavity resonator 21, concretely, in the region R1. The conductor part L1 extends in a direction parallel to the Z direction. The conductor part L1 is located at a position shifted from the center of gravity of the cavity resonator 21 seen in the Z direction, i.e., when the main body 50 is seen from a position distant from the main body 50 in the Z direction. In the present embodiment, in particular, the conductor part L1 is located at a position shifted in the X direction from the center of gravity of the cavity resonator 21 seen in the Z direction. The distance from the conductor part L1 to the plurality of through hole lines T7 is smaller than the distance from the conductor part L1 to the plurality of through hole lines T3.

The through hole line T2, i.e., the conductor part L2 of the path 5, is arranged in the cavity resonator 22, concretely, in the region R2. The conductor part L2 extends in a direction parallel to the Z direction. The conductor part L2 is located at a position shifted from the center of gravity of the cavity resonator 22 seen in the Z direction. In the present embodiment, in particular, the conductor part L2 is located at a position shifted in the −X direction from the center of gravity of the cavity resonator 22 seen in the Z direction. The distance from the conductor part L2 to the plurality of through hole lines T7 is smaller than the distance from the conductor part L1 to the plurality of through hole lines T4.

The size of the cavity resonator 21 in a direction parallel to the Z direction is smaller than the size of the cavity resonator 21 in a direction parallel to the bottom surface 50A (e.g., the size of the cavity resonator 21 in a direction parallel to the X direction and the size of the cavity resonator 21 in a direction parallel to the Y direction). A resonant mode of the cavity resonator 21 is TE011 mode.

The size of the cavity resonator 22 in a direction parallel to the Z direction is smaller than the size of the cavity resonator 22 in a direction parallel to the bottom surface 50A (e.g., the size of the cavity resonator 22 in a direction parallel to the X direction and the size of the cavity resonator 22 in a direction parallel to the Y direction). A resonant mode of the cavity resonator 22 is TE011 mode.

The cavity resonator 21 and the cavity resonator 22 are arranged in a direction parallel to the X direction. In the present embodiment, in particular, the cavity resonator 21 is arranged at a position closer to the side surface 50C than the side surface 50D. The cavity resonator 22 is arranged at a position closer to the side surface 50D than the side surface 50C.

The resonator conductor layer 601 constituting the resonator 11 extends from the outside of the region R1 to the inside of the region R1. The resonator conductor layer 602 constituting the resonator 12 extends from the outside of the region R2 to the inside of the region R2.

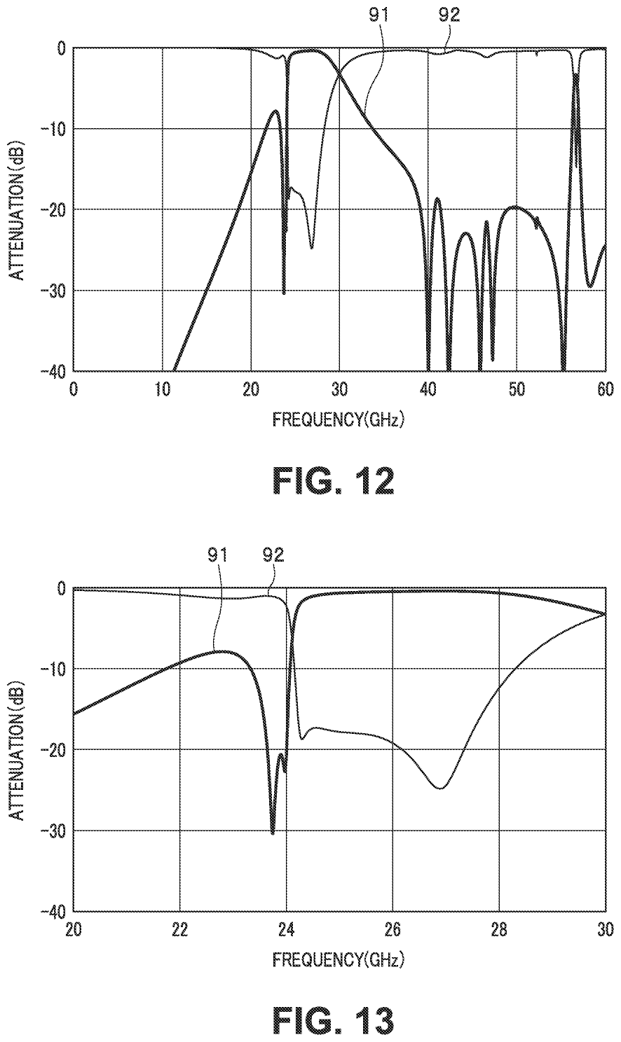

Next, an example of a frequency response of the filter 1 according to the present embodiment will be described. FIG. 12 is a characteristic diagram illustrating an example of the frequency response of the filter 1. FIG. 13 is a characteristic diagram illustrating part of the frequency response illustrated in FIG. 12, concretely a frequency region near the passband, in an enlarged manner. In each of FIG. 12 and FIG. 13, the horizontal axis represents frequency, and the vertical axis represents attenuation. In each of FIG. 12 and FIG. 13, the curved line to which the reference numeral 91 is added represents insertion loss, and the curved line to which the reference numeral 92 is added represents reflection loss.

In the example illustrated in FIG. 12 and FIG. 13, the center frequency of the stop band of the band elimination filter configured by the cavity resonators 21 and 22 is present in a lower frequency region of the passband of the band-pass filter configured by the circuit part 10. As illustrated in FIG. 12 and FIG. 13, according to the present embodiment, it is possible to obtain characteristics of abrupt change of insertion loss (attenuation) in a frequency region close to the passband. The amount of insertion loss in the passband (absolute value of attenuation) is a sufficiently small value.

The function and effects of the filter 1 according to the present embodiment will now be described. In the present embodiment, each of the cavity resonators 21 and 22 is coupled with the path 5 from the outside of the path 5 in the circuit configuration. With this, according to the present embodiment, coupling between the cavity resonators 21 and 22 and the first and second ports 3 and 4 can be weaker than coupling between the circuit part 10 and the first and second ports 3 and 4. With this, according to the present embodiment, an influence of the cavity resonators 21 and 22 on the characteristics of the entire filter 1 can be adjusted, i.e., suppressed.

In the present embodiment, the conductor part L1 of the path 5 is located at a position shifted in the X direction from the center of gravity of the cavity resonator 21 seen in the Z direction. In the present embodiment, by adjusting the distance from the conductor part L1 to the plurality of through hole lines T7, the strength of coupling between the cavity resonator 21 and the path 5 can be adjusted. Specifically, when the distance from the conductor part L1 to the plurality of through hole lines T7 is adjusted to be smaller, the coupling between the cavity resonator 21 and the path 5 becomes weaker. The distance from the conductor part L1 to the plurality of through hole lines T7 can be adjusted, for example, by shifting the positions of the plurality of through hole lines T7 in a direction parallel to the X direction.

Similarly, in the present embodiment, the conductor part L2 of the path 5 is located at a position shifted in the −X direction from the center of gravity of the cavity resonator 22 seen in the Z direction. In the present embodiment, by adjusting the distance from the conductor part L2 to the plurality of through hole lines T7, the strength of coupling between the cavity resonator 22 and the path 5 can be adjusted. Specifically, when the distance from the conductor part L2 to the plurality of through hole lines T7 is adjusted to be smaller, the coupling between the cavity resonator 22 and the path 5 becomes weaker. The distance from the conductor part L2 to the plurality of through hole lines T7 can be adjusted, for example, by shifting the positions of the plurality of through hole lines T7 in a direction parallel to the X direction.

In the present embodiment, the cavity resonators 21 and 22 are arranged in a direction parallel to the X direction. With this, according to the present embodiment, the size of the main body 50 in a direction parallel to the Z direction can be smaller than that in a case where the cavity resonators 21 and 22 are stacked together in a direction parallel to the Z direction.

### Second Embodiment

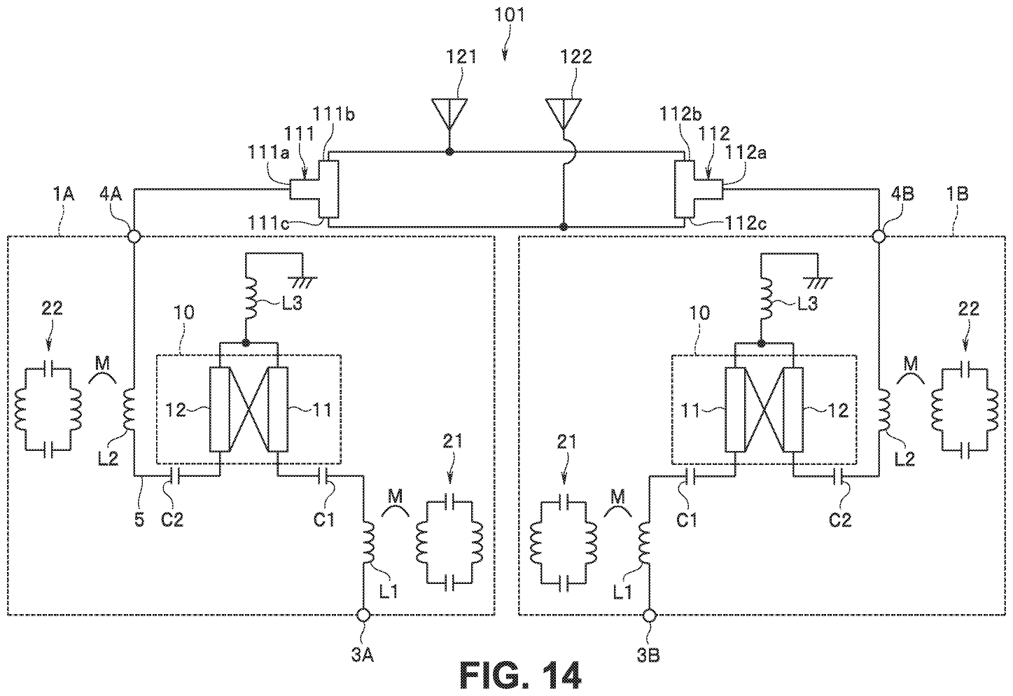

A second embodiment of the present invention will now be described. First, reference is made to FIG. 14 to describe an overview of a configuration of an antenna composite component 101 according to the present embodiment. FIG. 14 is a circuit diagram illustrating a circuit configuration of the antenna composite component 101.

The antenna composite component 101 includes a first filter 1A and a second filter 1B. A circuit configuration of each of the first and second filters 1A and 1B is the same as the circuit configuration of the filter 1 according to the first embodiment. Each of the first and second filters 1A and 1B functions as a band-pass filter similarly as the filter 1.

In the following description, components of the first and second filters 1A and 1B are denoted by the same reference numerals and signs as those of the components of the filter 1, excluding the first and second ports. The first port of the first filter 1A is denoted by a reference sign 3A, the second port of the first filter 1A is denoted by a reference sign 4A, the first port of the second filter 1B is denoted by a reference sign 3B, and the second port of the second filter 1B is denoted by a reference sign 4B.

The antenna composite component 101 further includes two dividers 111 and 112 and two antennas 121 and 122. The divider 111 includes a first end 111a, a second end 111b, and a third end 111c. The divider 112 includes a first end 112a, a second end 112b, and a third end 112c.

The second port 4A of the first filter 1A is connected to the first end 111a of the divider 111. The second end 111b of the divider 111 is connected to the antenna 121. The third end 111c of the divider 111 is connected to the antenna 122. The divider 111 has a function of dividing signals output from the second port 4A of the first filter 1A to the antennas 121 and 122.

The second port 4B of the second filter 1B is connected to the first end 112a of the divider 112. The second end 112b of the divider 112 is connected to the antenna 121. The third end 112c of the divider 112 is connected to the antenna 122. The divider 112 has a function of dividing signals output from the second port 4B of the second filter 1B to the antennas 121 and 122.

Each of the antennas 121 and 122 is connected to the second port 4A of the first filter 1A via the divider 111 and is also connected to the second port 4B of the second filter 1B via the divider 112.

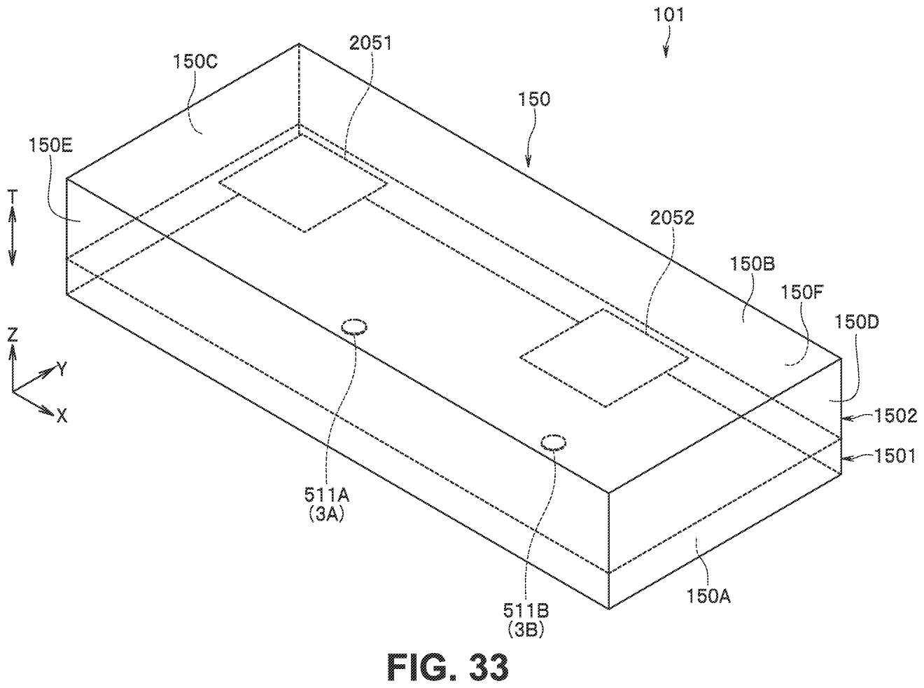

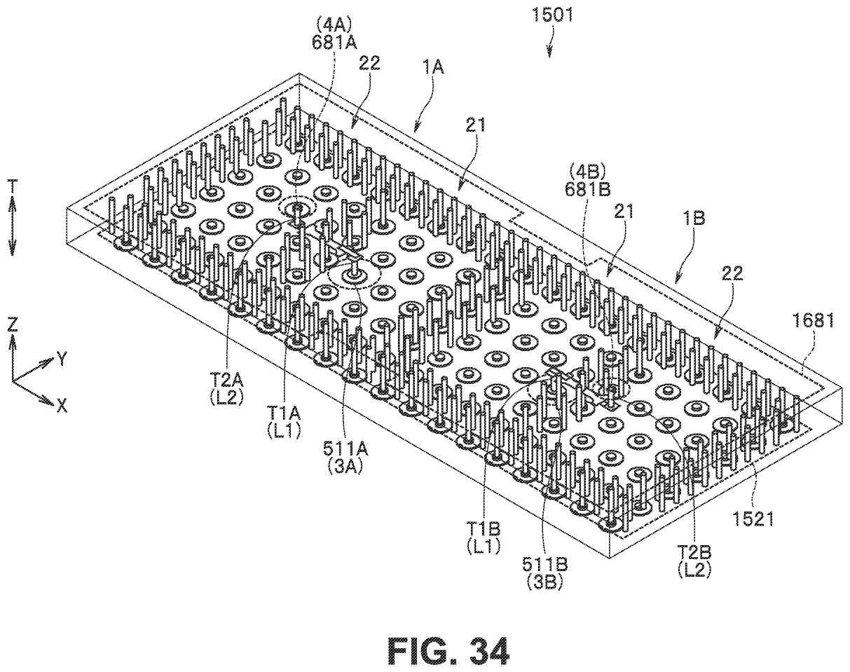

Next, a physical configuration of the antenna composite component 101 will be described. The antenna composite component 101 includes a main body 150 for integrating the components of the antenna composite component 101 described with reference to FIG. 14. The first filter 1A, the second filter 1B, the dividers 111 and 112, and the antennas 121 and 122 are integrated into the main body 150. The main body 150 is also a main body for integrating the components of the first filter 1A. Similarly, the main body 150 is also a main body for integrating the components of the second filter 1B. Note that the main body 150 is illustrated in FIG. 33 and FIG. 34 to be described later.

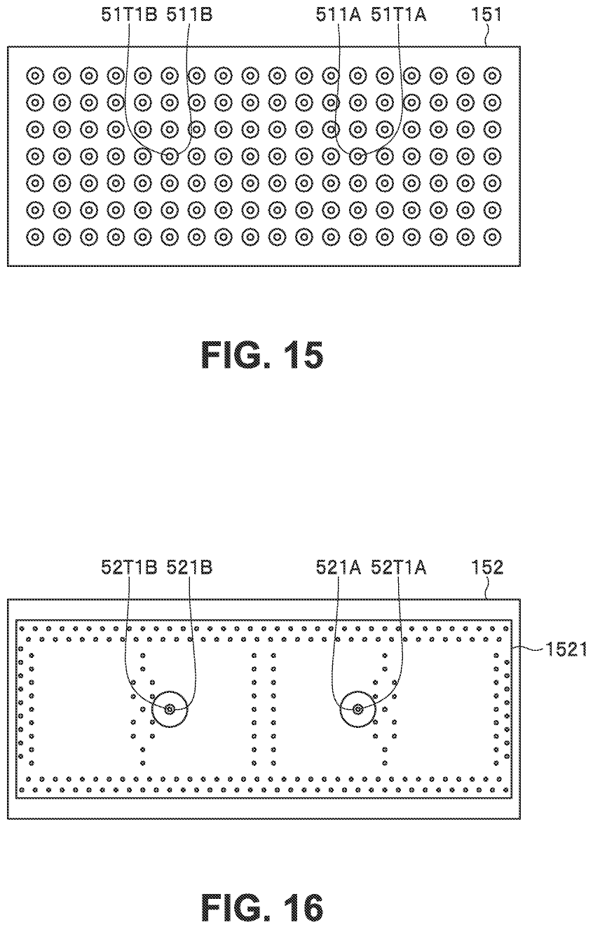

The main body 150 includes a plurality of dielectric layers stacked together and a plurality of conductor layers and a plurality of through holes formed in the plurality of dielectric layers. Reference is now made to FIG. 15 to FIG. 32 to describe the plurality of dielectric layers and the plurality of conductor layers constituting the main body 150. In the present embodiment, the main body 150 includes fifty-five dielectric layers stacked together. The fifty-five dielectric layers will be referred to as the first to fifty-fifth dielectric layers in the order from bottom to top. The first to fifty-fifth dielectric layers are denoted by reference numerals 151 to 205, respectively.

FIG. 15 illustrates a patterned surface of the first dielectric layer 151. A plurality of conductor layers are formed on the patterned surface of the dielectric layer 151. The plurality of dielectric layers include conductor layers 511A and 511B. A plurality of through holes connected to the plurality of respective conductor layers are formed in the dielectric layer 151. The plurality of through holes include particular through holes 51T1A and 51T1B connected respectively to the conductor layers 511A and 511B. In FIG. 15, a plurality of first circles and a plurality of second circles located inside the plurality of respective first circles are illustrated. Each first circle represents a conductor layer, and each second circle represents a through hole.

FIG. 16 illustrates a patterned surface of the second dielectric layer 152. Conductor layers 521A, 521B, and 1521 are formed on the patterned surface of the dielectric layer 152. The particular through holes 51T1A and 51T1B formed in the dielectric layer 151 are connected respectively to the conductor layers 521A and 521B. The plurality of through holes (excluding the particular through holes 51T1A and 51T1B) formed in the dielectric layer 151 are connected to the conductor layer 1521. In the dielectric layer 152, two particular through holes 52T1A and 52T1B connected respectively to the conductor layers 521A and 521B and a plurality of through holes connected to the conductor layer 1521 are formed. In FIG. 16, each circle illustrated in the conductor layer 1521 represents a through hole.

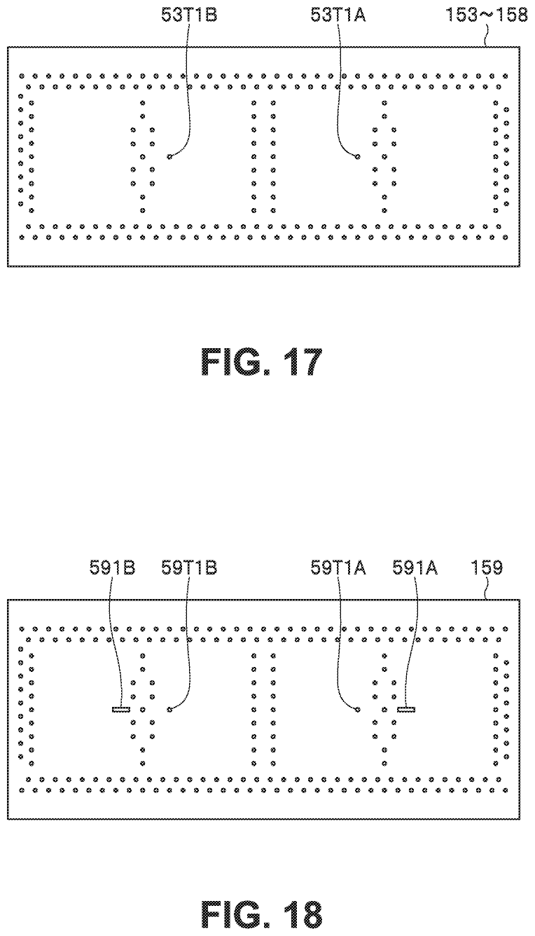

FIG. 17 illustrates a patterned surface of each of the third to eighth dielectric layers 153 to 158. A plurality of through holes are formed in each of the dielectric layers 153 to 158. The plurality of through holes include particular through holes 53T1A and 53T1B formed in each of the dielectric layers 153 to 158. The particular through holes 52T1A and 52T1B formed in the dielectric layer 152 are connected respectively to the particular through holes 53T1A and 53T1B formed in the dielectric layer 153. In FIG. 17, each circle represents a through hole. In the dielectric layers 153 to 158, every vertically adjacent through holes are connected to each other.

FIG. 18 illustrates a patterned surface of the ninth dielectric layer 159. Conductor layers 591A and 591B are formed on the patterned surface of the dielectric layer 159. A plurality of through holes are formed in the dielectric layer 159. The plurality of through holes include two particular through holes 59T1A and 59T1B connected respectively to the particular through holes 53T1A and 53T1B formed in the dielectric layer 158. In FIG. 18, each circle represents a through hole.

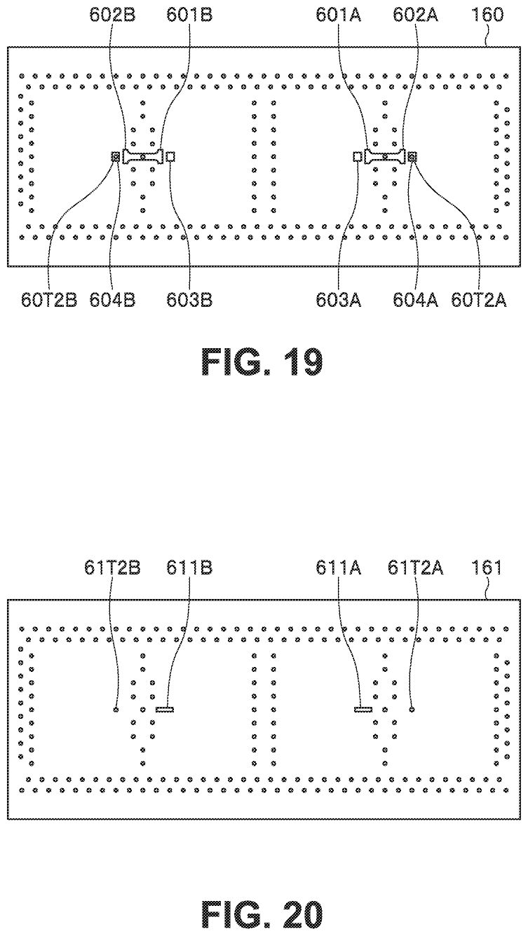

FIG. 19 illustrates a patterned surface of the tenth dielectric layer 160. Resonator conductor layers 601A, 601B, 602A, and 602B and conductor layers 603A, 603B, 604A, and 604B are formed on the patterned surface of the dielectric layer 160. Each of the conductor layers 601A, 601B, 602A, and 602B has a first end and a second end located opposite to each other. The first end of the conductor layer 601A and the first end of the conductor layer 602A are connected to each other. The second end of the conductor layer 601A is at a predetermined distance from and adjacent to the conductor layer 603A. The second end of the conductor layer 602A is at a predetermined distance from and adjacent to the conductor layer 604A. The particular through hole 59T1A formed in the dielectric layer 159 is connected to the conductor layer 603A.

The first end of the conductor layer 601B and the first end of the conductor layer 602B are connected to each other. The second end of the conductor layer 601B is at a predetermined distance from and adjacent to the conductor layer 603B. The second end of the conductor layer 602B is at a predetermined distance from and adjacent to the conductor layer 604B. The particular through hole 59T1B formed in the dielectric layer 159 is connected to the conductor layer 603B.

A plurality of through holes are formed in the dielectric layer 160. The plurality of through holes include two particular through holes 60T2A and 60T2B connected respectively to the conductor layers 604A and 604B. In FIG. 19, each circle represents a through hole.

FIG. 20 illustrates a patterned surface of the eleventh dielectric layer 161. Conductor layers 611A and 611B are formed on the patterned surface of the dielectric layer 161. A plurality of through holes are formed in the dielectric layer 161. The plurality of through holes include two particular through holes 61T2A and 61T2B connected respectively to the particular through holes 60T2A and 60T2B formed in the dielectric layer 160. In FIG. 20, each circle represents a through hole.

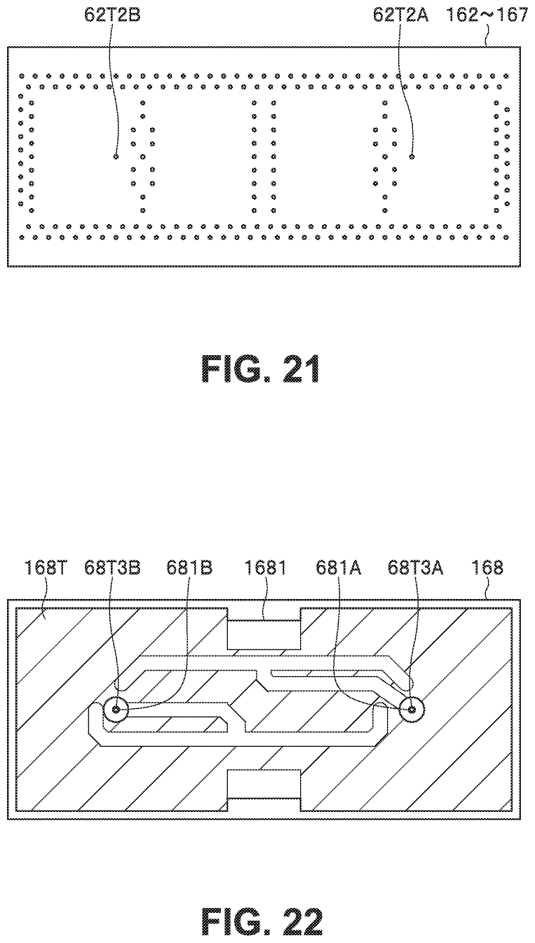

FIG. 21 illustrates a patterned surface of each of the twelfth to seventeenth dielectric layers 162 to 167. A plurality of through holes are formed in each of the dielectric layers 162 to 167. The plurality of through holes include particular through holes 62T2A and 62T2B formed in each of the dielectric layers 162 to 167. The particular through holes 61T2A and 61T2B formed in the dielectric layer 161 are connected respectively to the particular through holes 62T2A and 62T2B formed in the dielectric layer 162. In FIG. 21, each circle represents a through hole. In the dielectric layers 162 to 167, every vertically adjacent through holes are connected to each other.

FIG. 22 illustrates a patterned surface of the eighteenth dielectric layer 168. Conductor layers 681A, 681B, and 1681 are formed on the patterned surface of the dielectric layer 168. The particular through holes 62T2A and 62T2B formed in the dielectric layer 167 are connected respectively to the conductor layers 681A and 681B. The plurality of through holes (excluding the particular through holes 62T2A and 62T2B) formed in the dielectric layer 167 are connected to the conductor layer 1681.

In the dielectric layer 168, two particular through holes 68T3A and 68T3B connected respectively to the conductor layers 681A and 681B, and a plurality of through holes connected to the conductor layer 1681 are formed. In FIG. 22, a hatched region 168T represents a region in which the plurality of through holes are formed. The plurality of through holes are preferably arranged in a region 168T evenly with a predetermined distance from each other. Note that, also in the drawings similar to FIG. 22 to be described below, a plurality of through holes excluding particular through holes are represented similarly to those in FIG. 22.

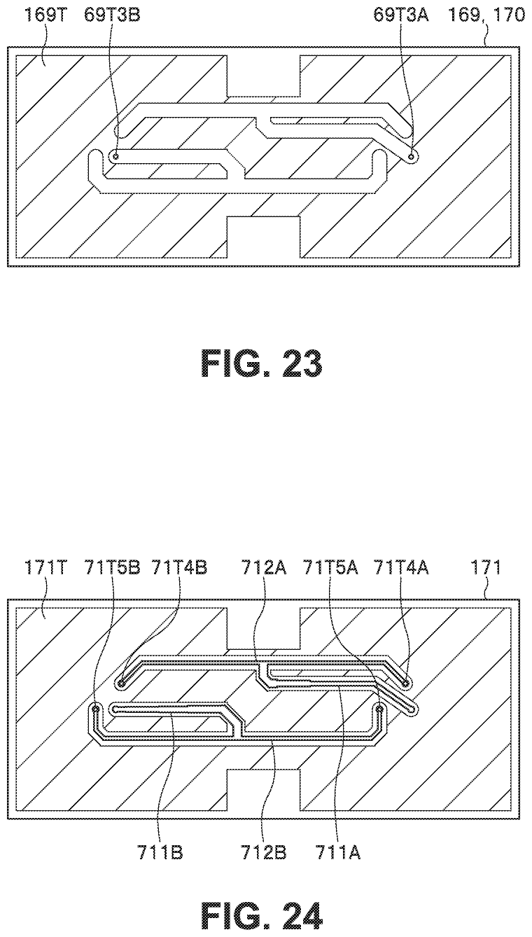

FIG. 23 illustrates a patterned surface of each of the nineteenth and twentieth dielectric layers 169 and 170. A plurality of through holes are formed in each of the dielectric layers 169 and 170. The plurality of through holes include particular through holes 69T3A and 69T3B formed in each of the dielectric layers 169 and 170. The particular through holes 68T3A and 68T3B formed in the dielectric layer 168 are connected respectively to the particular through holes 69T3A and 69T3B formed in the dielectric layer 169. The plurality of through holes (excluding the particular through holes 68T3A and 68T3B) formed in the dielectric layer 168 are connected to the plurality of through holes (excluding the particular through holes 69T3A and 69T3B) formed in the dielectric layer 169. In FIG. 23, a hatched region 169T represents a region in which the plurality of through holes are formed. In the dielectric layers 169 and 170, every vertically adjacent through holes are connected to each other.

FIG. 24 illustrates a patterned surface of the twenty-first dielectric layer 171. Conductor layers 711A, 711B, 712A, and 712B are formed on the patterned surface of the dielectric layer 171. Each of the conductor layers 711A, 711B, 712A, and 712B has a first end and a second end located opposite to each other. The particular through hole 69T3A formed in the dielectric layer 170 is connected to a portion of the conductor layer 711A near the first end thereof. The second ends of the conductor layer 711A is connected to the conductor layer 712A. The particular through hole 69T3B formed in the dielectric layer 170 is connected to a portion of the conductor layer 711B near the first end thereof. The second end of the conductor layer 711B is connected to the conductor layer 712B.

A plurality of through holes are formed in the dielectric layer 171. The plurality of through holes include four particular through holes 71T4A, 71T4B, 71T5A, and 71T5B. The particular through hole 71T4A is connected to a portion of the conductor layer 712A near the first end thereof. The particular through hole 71T5A is connected to a portion of the conductor layer 712B near the first end thereof. The particular through hole 71T4B is connected to a portion of the conductor layer 712A near the second end thereof. The particular through hole 71T5B is connected to a portion of the conductor layer 712B near the second end thereof. In FIG. 24, a hatched region 171T represents a region in which the plurality of through holes excluding the particular through holes 71T4A, 71T4B, 71T5A, and 71T5B are formed. The region 171T has such a shape as to surround the conductor layers 711A, 711B, 712A, and 712B.

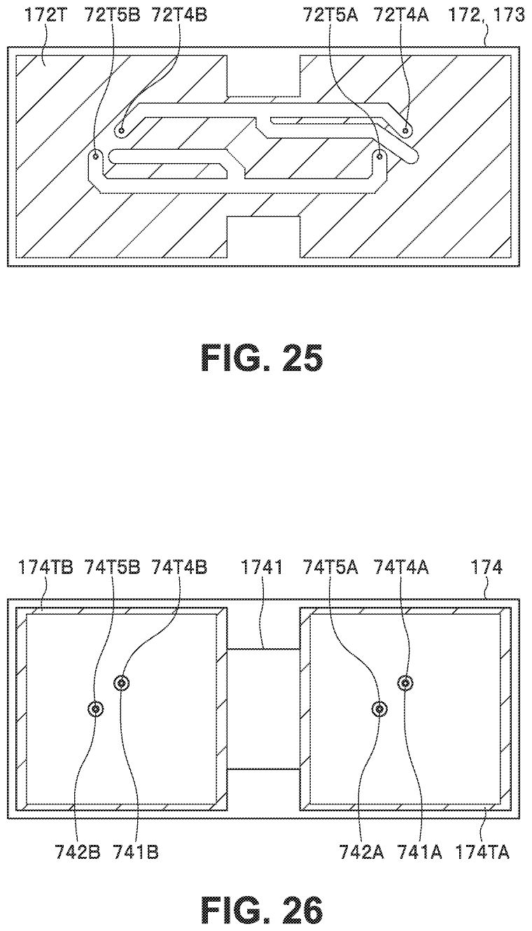

FIG. 25 illustrates a patterned surface of each of the twenty-second and twenty-third dielectric layers 172 and 173. A plurality of through holes are formed in each of the dielectric layers 172 and 173. The plurality of through holes include particular through holes 72T4A, 72T4B, 72T5A, and 72T5B formed in each of the dielectric layers 172 and 173. The particular through holes 71T4A, 71T4B, 71T5A, and 71T5B formed in the dielectric layer 171 are connected respectively to the particular through holes 72T4A, 72T4B, 72T5A, and 72T5B formed in the dielectric layer 172. In FIG. 25, a hatched region 172T represents a region in which the plurality of through holes excluding the particular through holes 72T4A, 72T4B, 72T5A, and 72T5B are formed. In the dielectric layers 172 and 173, every vertically adjacent through holes are connected to each other.

FIG. 26 illustrates a patterned surface of the twenty-fourth dielectric layer 174. Conductor layers 741A, 741B, 742A, 742B, and 1741 are formed on the patterned surface of the dielectric layer 174. The particular through holes 72T4A, 72T4B, 72T5A, and 72T5B formed in the dielectric layer 173 are connected respectively to the conductor layers 741A, 741B, 742A, and 742B. The plurality of through holes (excluding the particular through holes 72T4A, 72T4B, 72T5A, and 72T5B) formed in the dielectric layer 173 are connected to the conductor layer 1741.

A plurality of through holes are formed in the dielectric layer 174. The plurality of through holes include four particular through holes 74T4A, 74T4B, 74T5A, and 74T5B connected respectively to the conductor layers 741A, 741B, 742A, and 742B. In FIG. 26, hatched regions 174TA and 174TB represent regions in which the plurality of through holes excluding the four particular through holes 74T4A, 74T4B, 74T5A, and 74T5B are formed. The region 174TA has such a shape as to surround the conductor layers 741A and 742A. The region 174TB has such a shape as to surround the conductor layers 741B and 742B.

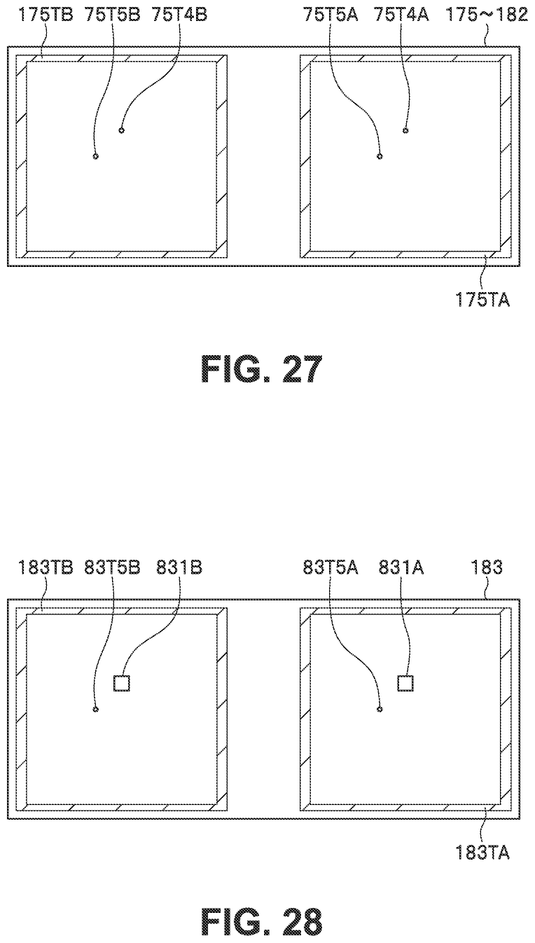

FIG. 27 illustrates a patterned surface of each of the twenty-fifth to thirty-second dielectric layers 175 to 182. A plurality of through holes are formed in each of the dielectric layers 175 to 182. The plurality of through holes include particular through holes 75T4A, 75T4B, 75T5A, and 75T5B formed in each of the dielectric layers 175 and 182. The particular through holes 74T4A, 74T4B, 74T5A, and 74T5B formed in the dielectric layer 174 are connected respectively to the particular through holes 75T4A, 75T4B, 75T5A, and 75T5B formed in the dielectric layer 175. In FIG. 27, hatched regions 175TA and 175TB represent regions in which the plurality of through holes excluding the particular through holes 75T4A, 75T4B, 75T5A, and 75T5B are formed. In the dielectric layers 175 to 182, every vertically adjacent through holes are connected to each other.

FIG. 28 illustrates a patterned surface of the thirty-third dielectric layer 183. Conductor layers 831A and 831B are formed on the patterned surface of the dielectric layer 183. The particular through holes 75T4A and 75T4B formed in the dielectric layer 182 are connected respectively to the conductor layers 831A and 831B.

A plurality of through holes are formed in the dielectric layer 183. The plurality of through holes include two particular through holes 83T5A and 83T5B connected respectively to the particular through holes 75T5A and 75T5B formed in the dielectric layer 182. In FIG. 28, hatched regions 183TA and 183TB represent regions in which the plurality of through holes excluding the particular through holes 83T5A and 83T5B are formed. The region 183TA has such a shape as to surround the conductor layer 831A. The region 183TB has such a shape as to surround the conductor layer 831B.

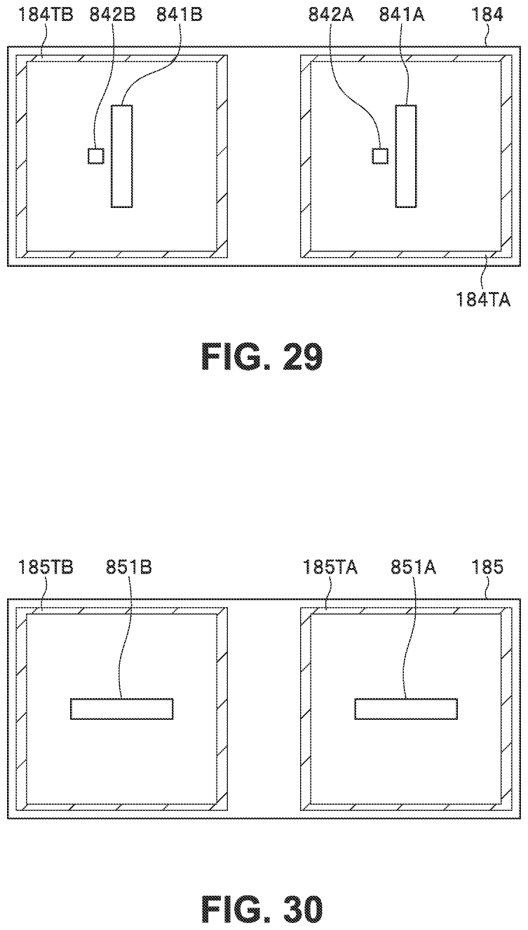

FIG. 29 illustrates a patterned surface of the thirty-fourth dielectric layer 184. Conductor layers 841A, 841B, 842A, and 842B are formed on the patterned surface of the dielectric layer 184. The particular through holes 83T5A and 83T5B formed in the dielectric layer 183 are connected respectively to the conductor layers 842A and 842B. A plurality of through holes are formed in the dielectric layer 184. In FIG. 29, hatched regions 184TA and 184TB represent regions in which the plurality of through holes are formed. The region 184TA has such a shape as to surround the conductor layers 841A and 842A. The region 184TB has such a shape as to surround the conductor layers 841B and 842B.

FIG. 30 illustrates a patterned surface of the thirty-fifth dielectric layer 185. Conductor layers 851A and 851B are formed on the patterned surface of the dielectric layer 185. A plurality of through holes are formed in the dielectric layer 185. In FIG. 30, hatched regions 185TA and 185TB represent regions in which the plurality of through holes are formed. The region 185TA has such a shape as to surround the conductor layer 851A. The region 185TB has such a shape as to surround the conductor layer 851B.

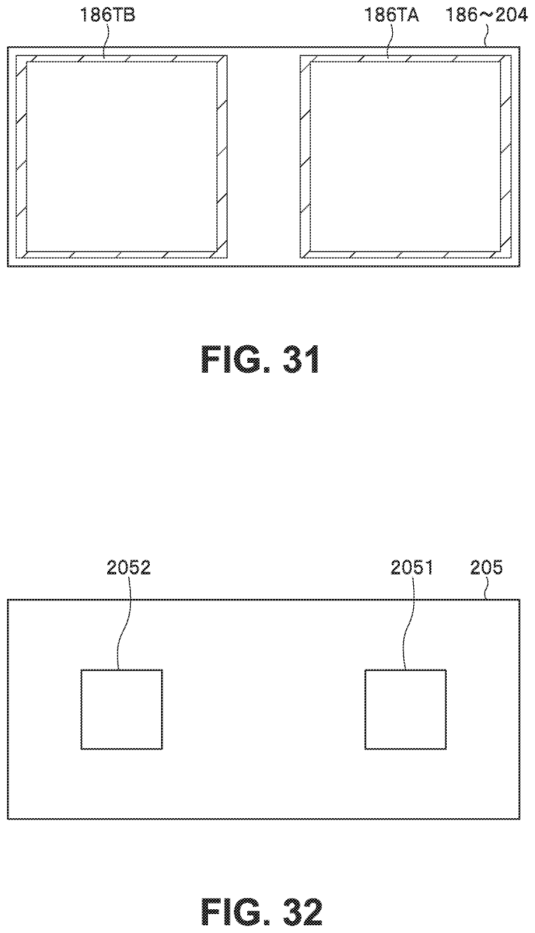

FIG. 31 illustrates a patterned surface of each of the thirty-sixth to fifty-fourth dielectric layers 186 to 204. A plurality of through holes are formed in each of the dielectric layers 186 to 204. In FIG. 31, hatched regions 186TA and 186TB represent regions in which the plurality of through holes are formed. In the dielectric layers 186 to 204, every vertically adjacent through holes are connected to each other.

FIG. 32 illustrates a patterned surface of the fifty-fifth dielectric layer 205. Conductor layers 2051 and 2052 are formed on the patterned surface of the dielectric layer 205.

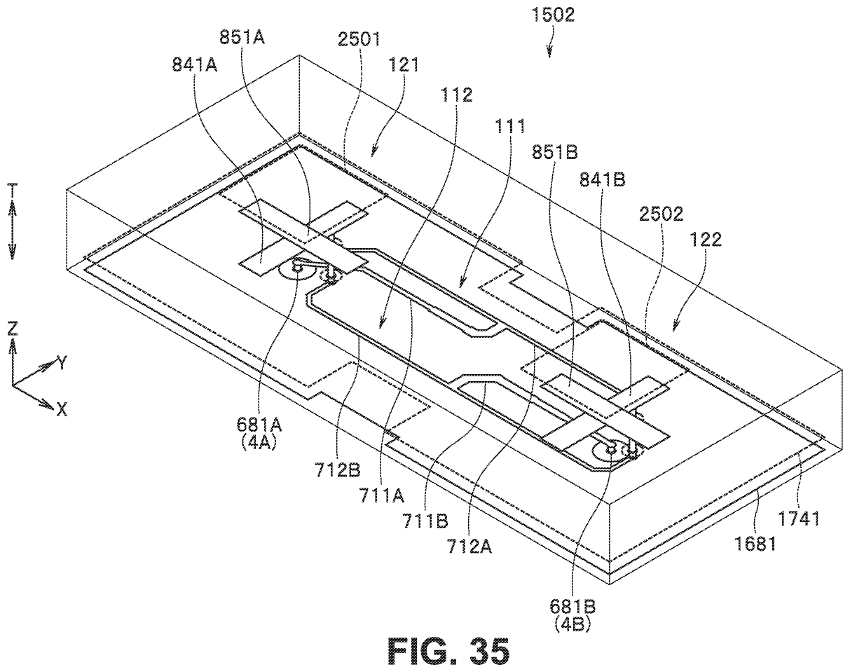

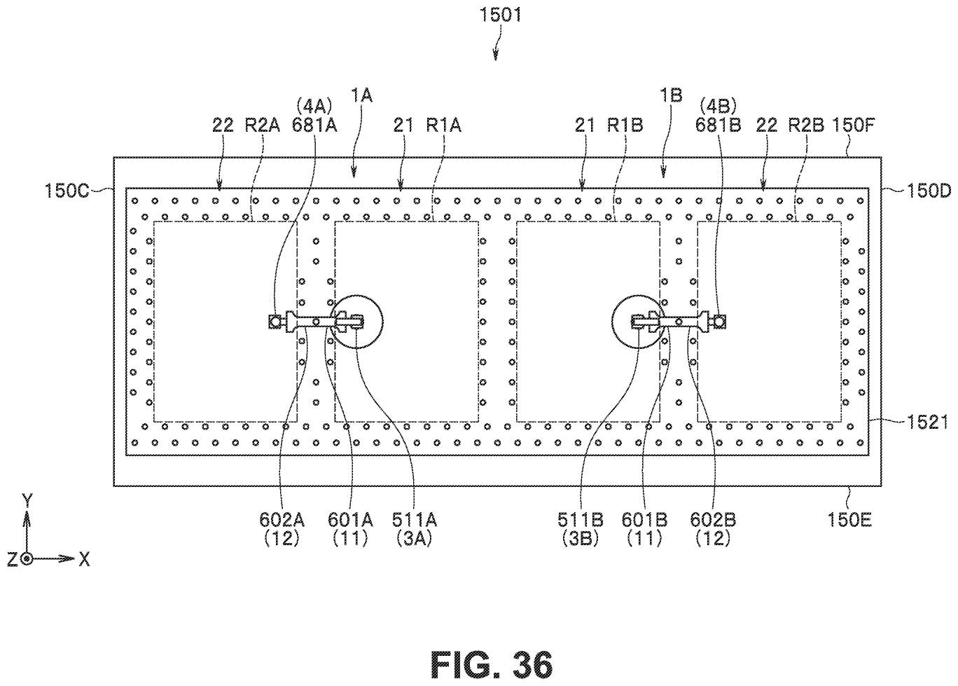

FIG. 33 illustrates the main body 150 formed by stacking the first to fifty-fifth dielectric layers 151 to 205. FIG. 34 illustrates inside of a portion including the dielectric layers 151 to 167 (referred to as a first portion 1501 below) of the main body 150. FIG. 35 illustrates inside of a portion including the dielectric layers 168 to 205 (referred to as a second portion 1502 below) of the main body 150. Note that, in FIG. 35, the plurality of through holes excluding the plurality of particular through holes are omitted. FIG. 36 is a plan view illustrating the inside of the first portion 1501.

The main body 150 has a bottom surface 150A and a top surface 150B located at opposite ends of the plurality of dielectric layers in the stacking direction T, and four side surfaces 150C to 150F connecting the bottom surface 150A and the top surface 150B. The side surfaces 150C and 150D face opposite to each other, and also the side surfaces 150E and 150F face opposite to each other. The side surfaces 150C to 150F are perpendicular to the bottom surface 150A and the top surface 150B.

In FIG. 33, the X direction, the Y direction, and the Z direction defined in FIG. 9 in the first embodiment are illustrated. In the present embodiment, as in the first embodiment, one direction parallel to the stacking direction T is the Z direction. As illustrated in FIG. 33, the bottom surface 150A is located at a −Z-direction end of the main body 150. The top surface 150B is located at a Z-direction end of the main body 150. The side surface 150C is located at a −X-direction end of the main body 150. The side surface 150D is located at an X-direction end of the main body 150. The side surface 150E is located at a −Y-direction end of the main body 150. The side surface 150F is located at a Y-direction end of the main body 150.

The bottom surface 150A and the top surface 150B face opposite to each other. The bottom surface 150A corresponds to the “first surface” in the present invention. The top surface 150B corresponds to the “second surface” in the present invention.

The main body 150 is formed by stacking the first to fifty-fifth dielectric layers 151 to 205 such that the patterned surface of the first dielectric layer 151 also serves as the bottom surface 150A of the main body 150 and a surface opposite to the patterned surface of the fifty-fifth dielectric layer 205 also serves as the top surface 150B of the main body 150. As illustrated in FIG. 34 and FIG. 35, the plurality of conductor layers and the plurality of through holes illustrated in FIG. 15 to FIG. 32 are stacked inside the main body 150.

Each of the plurality of through holes illustrated in FIG. 15 to FIG. 31 excluding the above-described plurality of particular through holes is connected to the conductor layers overlapping the through hole in the stacking direction T or other through holes overlapping the through hole in the stacking direction T when the first to fifty-fifth dielectric layers 151 to 205 are stacked together. Each of the through holes located in each of the conductor layers among the plurality of through holes illustrated in FIG. 15 to FIG. 31 excluding the above-described plurality of particular through holes is connected to the conductor layer.

The planar shape (the shape seen in the Z direction) of each of the regions 168T, 169T, and 173T is the same as the planar shape of the region 171T. A plurality of through holes arranged in each of the regions 168T, 169T, 171T, and 173T are arranged to form a plurality of through hole lines when the first to fifty-fifth dielectric layers 151 to 205 are stacked together.

The planar shape of each of the regions 175TA and 183TA to 186TA is the same as the planar shape of the region 174TA. A plurality of through holes arranged in each of the regions 174TA, 175TA, and 183TA to 186TA are arranged to form a plurality of through hole lines when the first to fifty-fifth dielectric layers 151 to 205 are stacked together.

The planar shape of each of the regions 175TB and 183TB to 186TB is the same as the planar shape of the region 174TB. A plurality of through holes arranged in each of the regions 174TB, 175TB, and 183TB to 186TB are arranged to form a plurality of through hole lines when the first to fifty-fifth dielectric layers 151 to 205 are stacked together.

Correspondences of the components of antenna composite component 101 illustrated in FIG. 14 with the components in the main body 150 illustrated in FIG. 15 to FIG. 32 will now be described. First, components of the first filter 1A excluding the cavity resonators 21 and 22 will be described. The first port 3A is composed of the conductor layer 511A. The second port 4A is composed of the conductor layer 681A. In the present embodiment, the first port 3A is arranged on the bottom surface 150A of the main body 150. The second port 4A is arranged at a position different from the bottom surface 150A in a direction parallel to the Z direction.

In the first filter 1A, the resonator 11 of the circuit part 10 is composed of a resonator conductor layer 601A. The resonator 12 of the circuit part 10 is composed of a resonator conductor layer 602A. The capacitor C1 is composed of the resonator conductor layer 601A, the conductor layers 603A and 611A, and the dielectric layer 160 between these conductor layers. The capacitor C2 is composed of the resonator conductor layer 602A, the conductor layers 591A and 604A, and the dielectric layer 159 between these conductor layers. The conductor part L1 of the path 5 is composed of a through hole line T1A composed of the particular through holes 52T1A, 53T1A, and 59T1A. The conductor part L2 of the path 5 is composed of a through hole line T2A composed of the particular through holes 60T2A, 61T2A, and 62T2A.

Next, components of the second filter 1B excluding the cavity resonators 21 and 22 will be described. The first port 3B is composed of the conductor layer 511B. The second port 4B is composed of the conductor layer 681B. In the present embodiment, the first port 3B is arranged on the bottom surface 150A of the main body 150. The second port 4B is arranged at a position different from the bottom surface 150A in a direction parallel to the Z direction.

In the second filter 1B, the resonator 11 of the circuit part 10 is composed of a resonator conductor layer 601B. The resonator 12 of the circuit part 10 is composed of the resonator conductor layer 602B. The capacitor C1 is composed of the resonator conductor layer 601B, the conductor layers 603B and 611B, and the dielectric layer 160 between these conductor layers. The capacitor C2 is composed of the resonator conductor layer 602B, the conductor layers 591B and 604B, and the dielectric layer 159 between these conductor layers. The conductor part L1 of the path 5 is composed of a through hole line T1B composed of the particular through holes 52T1B, 53T1B, and 59T1B. The conductor part L2 of the path 5 is composed of a through hole line T2B composed of the particular through holes 60T2B, 61T2B, and 62T2B.

Next, the cavity resonators 21 and 22 of the first filter 1A and the cavity resonators 21 and 22 of the second filter 1B will be described. As illustrated in FIG. 36, in the first portion 1501 of the main body 150, four three-dimensional regions R1A, R1B, R2A, and R2B are present. The regions R1A, R1B, R2A, and R2B are arranged in the order of R2A, R1A, R1B, and R2B in a direction parallel to the X direction, from closest to farthest, from the side surface 150C.

In each of the regions R1A and R1B, a first dielectric is present. The first dielectric is composed of parts of the dielectric layers 152 to 167. In each of the regions R2A and R2B, a second dielectric is present. The second dielectric is composed of other parts of the dielectric layers 152 to 167.

The cavity resonator 21 of the first filter 1A is composed of a conductor surrounding the three-dimensional region R1A (the plurality of through holes and the conductor layers 1521 and 1681) and the first dielectric present in the region R1A (the parts of the dielectric layers 152 to 167). The cavity resonator 22 of the first filter 1A is composed of a conductor surrounding the three-dimensional region R2A (the plurality of through holes and the conductor layers 1521 and 1681) and the second dielectric present in the region R2A (the other parts of the dielectric layers 152 to 167).

The cavity resonator 21 of the second filter 1B is composed of a conductor surrounding the three-dimensional region R1B (the plurality of through holes and the conductor layers 1521 and 1681) and the first dielectric present in the region R1B (the parts of the dielectric layers 152 to 167). The cavity resonator 22 of the second filter 1B is composed of a conductor surrounding the three-dimensional region R2B (the plurality of through holes and the conductor layers 1521 and 1681) and the second dielectric present in the region R2B (other parts of the dielectric layers 152 to 167).

The plurality of conductors constituting the cavity resonators 21 and 22 of the first filter 1A and the cavity resonators 21 and 22 of the second filter 1B, excluding the conductor layer 1521, are connected to the conductor layer 1521. The plurality of through holes (excluding the particular through holes 51T1A and 51T1B) formed in the dielectric layer 151 are connected to the conductor layer 1521 and are also connected to the plurality of conductor layers (excluding the conductor layers 511A and 511B) formed on the patterned surface of the dielectric layer 151. The plurality of conductor layers (excluding the conductor layers 511A and 511B) formed on the patterned surface of the dielectric layer 151 are connected to the ground. Hence, the plurality of conductors constituting the cavity resonators 21 and 22 of the first filter 1A and the cavity resonators 21 and 22 of the second filter 1B are connected to the ground.

The cavity resonator 21 and the cavity resonator 22 of the first filter 1A are arranged in a direction parallel to the X direction. The cavity resonator 21 and the cavity resonator 22 of the second filter 1B are also arranged in a direction parallel to the X direction. In the present embodiment, in particular, all the cavity resonators of the first and second filters 1A and 1B are arranged in a direction parallel to the X direction.

Next, the dividers 111 and 112 will be described. The divider 111 is composed of the conductor layers 711A and 712A. The conductor layer 711A is connected to the conductor layer 681A constituting the second port 4A of the first filter 1A via the particular through holes 68T3A and 69T3A.

The divider 112 is composed of the conductor layers 711B and 712B. The conductor layer 711B is connected to the conductor layer 681B constituting the second port 4B of the second filter 1B via the particular through holes 68T3B and 69T3B.

Next, the antennas 121 and 122 will be described. The antenna 121 is composed of the conductor layer 2051 functioning as a radiation conductor and the conductor layers 841A and 851A functioning as feeder conductors. The conductor layer 841A extends in a direction parallel to the Y direction. The conductor layer 841A supplies a vertical polarization signal to the conductor layer 2051. The conductor layer 851A extends in a direction parallel to the X direction. The conductor layer 851A supplies a horizontal polarization signal to the conductor layer 2051.

The conductor layer 841A faces the conductor layer 831A via the dielectric layer 183 and is capacitive-coupled with the conductor layer 831A. The conductor layer 831A is connected to a portion of the conductor layer 712A constituting the divider 111, near the first end of the conductor layer 712A, via the particular through holes 71T4A and 72T4A, the conductor layer 741A, and the particular through holes 74T4A and 75T4A.

The conductor layer 851A faces the conductor layer 842A via the dielectric layer 184 and is capacitive-coupled with the conductor layer 842A. The conductor layer 842A is connected to a portion of the conductor layer 712B constituting the divider 112, near the first end of the conductor layer 712B, via the particular through holes 71T5A and 72T5A, the conductor layer 742A, and the particular through holes 74T5A, 75T5A, and 83T5A.

The antenna 122 is composed of the conductor layer 2052 functioning as a radiation conductor and the conductor layers 841B and 851B functioning as feeder conductors. The conductor layer 841B extends in a direction parallel to the Y direction. The conductor layer 841B supplies a vertical polarization signal to the conductor layer 2052. The conductor layer 851B extends in a direction parallel to the X direction. The conductor layer 851B supplies a horizontal polarization signal to the conductor layer 2052.

The conductor layer 841B faces the conductor layer 831B via the dielectric layer 183 and is capacitive-coupled with the conductor layer 831B. The conductor layer 831B is connected to a portion of the conductor layer 712A constituting the divider 111, near the second end of the conductor layer 712A, via the particular through holes 71T4B and 72T4B, the conductor layer 741B, and the particular through holes 74T4B and 75T4B.

The conductor layer 851B faces the conductor layer 842B via the dielectric layer 184 and is capacitive-coupled with the conductor layer 842B. The conductor layer 842B is connected to a portion of the conductor layer 712B constituting the divider 112, near the second end of the conductor layer 712B, via the particular through holes 71T5B and 72T5B, the conductor layer 742B, and the particular through holes 74T5B, 75T5B, and 83T5B.

The other configuration, function, and effects of the present embodiment are the same as those of the first embodiment.

### Third Embodiment

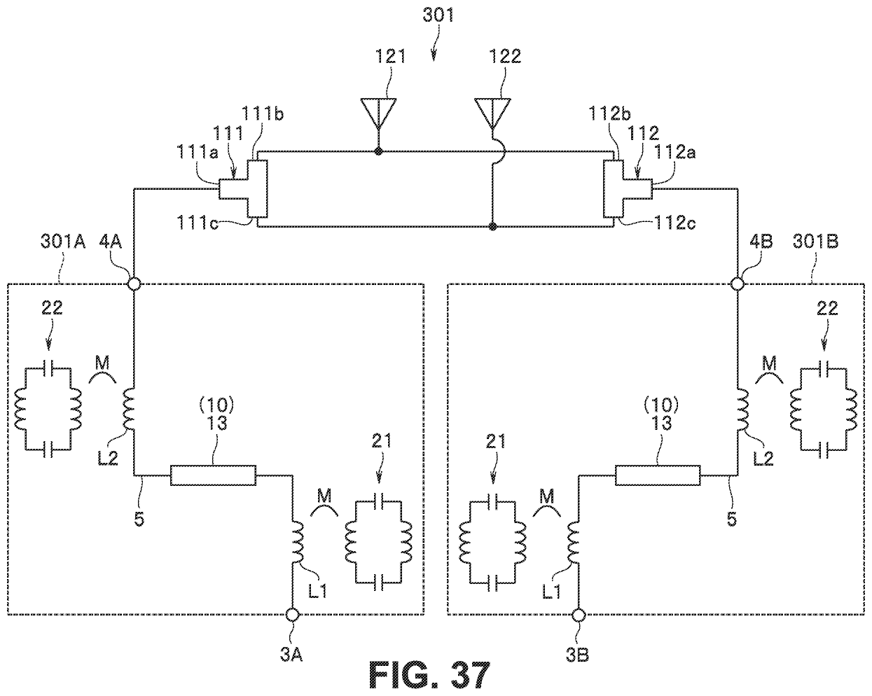

A third embodiment of the present invention will now be described. First, reference is made to FIG. 37 to describe an overview of a configuration of an antenna composite component 301 according to the present embodiment. FIG. 34 is a circuit diagram illustrating a circuit configuration of the antenna composite component 301.

The configuration of the antenna composite component 301 according to the present embodiment is different from the configuration of the antenna composite component 101 according to the second embodiment in terms of the following respects. The antenna composite component 301 includes first and second filters 301A and 301B instead of the first and second filters 1A and 1B of the second embodiment.

A configuration of the first filter 301A is the same as the configuration of the first filter 1A excluding the circuit part 10 and the capacitors C1 and C2. A configuration of the second filter 301B is the same as the configuration of the second filter 1B excluding the circuit part 10 and the capacitors C1 and C2. In the present embodiment, the circuit part 10 of the first filter 301A and the circuit part 10 of the second filter 301B are both lines 13. The capacitors C1 and C2 are not provided in both the first and second filters 301A and 301B.

Next, the respects in which the configuration of the main body 150 of the antenna composite component 301 is different from the configuration of the main body 150 of the antenna composite component 101 according to the second embodiment will be described. In the present embodiment, the main body 150 includes second to seventeenth dielectric layers 252 to 267 instead of the second to seventeenth dielectric layers 152 to 167 of the first embodiment.

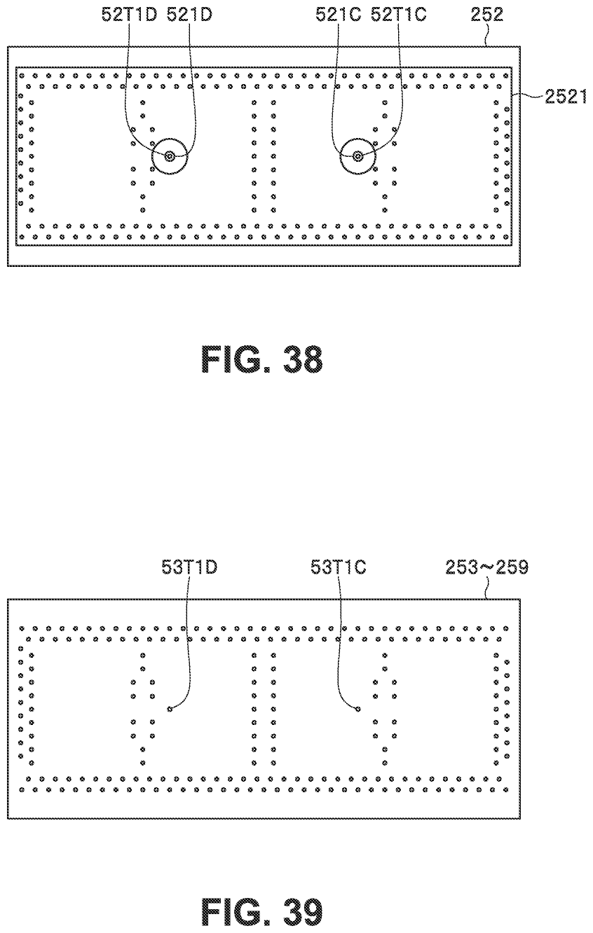

FIG. 38 illustrates a patterned surface of the second dielectric layer 252. Conductor layers 521C, 521D, and 2521 are formed on the patterned surface of the dielectric layer 252. The particular through holes 51T1A and 51T1B formed in the dielectric layer 151 (refer to FIG. 15) are connected respectively to the conductor layers 521C and 521D. The plurality of through holes (excluding the particular through holes 51T1A and 51T1B) formed in the dielectric layer 151 are connected to the conductor layer 2521. In the dielectric layer 252, two particular through holes 52T1C and 52T1D connected respectively to the conductor layers 521C and 521D, and a plurality of through holes connected to the conductor layer 2521 are formed. In FIG. 38, each circle illustrated in the conductor layer 2521 represents a through hole.

FIG. 39 illustrates a patterned surface of each of the third to ninth dielectric layers 253 to 259. A plurality of through holes are formed in each of the dielectric layers 253 to 259. The plurality of through holes include particular through holes 53T1C and 53T1D formed in each of the dielectric layers 253 to 259. The particular through holes 52T1C and 52T1D formed in the dielectric layer 252 are connected respectively to the particular through holes 53T1C and 53T1D formed in the dielectric layer 253. In FIG. 39, each circle represents a through hole. In the dielectric layers 253 to 259, every vertically adjacent through holes are connected to each other.

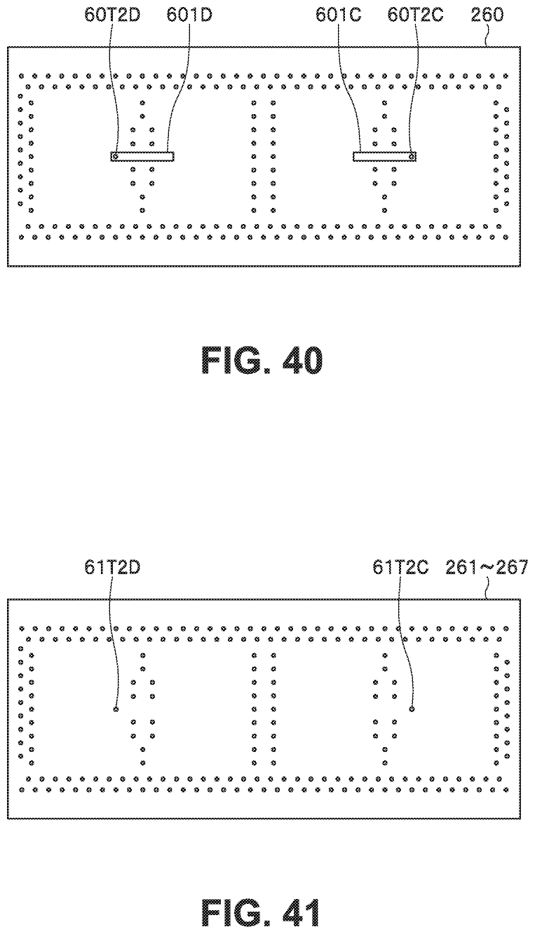

FIG. 40 illustrates a patterned surface of the tenth dielectric layer 260. Conductor layers 601C and 601D are formed on the patterned surface of the dielectric layer 260. Each of the conductor layers 601C and 601D has a first end and a second end located opposite to each other. The particular through hole 53T1C formed in the dielectric layer 259 is connected to a portion of the conductor layer 601C near the first end thereof. The particular through hole 53T1D formed in the dielectric layer 259 is connected to a portion of the conductor layer 601D near the first end thereof.

A plurality of through holes are formed in the dielectric layer 260. The plurality of through holes include two particular through holes 60T2C and 60T2D. The particular through hole 60T2C is connected to a portion of the conductor layer 601C near the second end thereof. The particular through hole 60T2D is connected to a portion of the conductor layer 601D near the second end thereof. In FIG. 40, each circle represents a through hole.

FIG. 41 illustrates a patterned surface of each of the eleventh to seventeenth dielectric layers 261 to 267. A plurality of through holes are formed in each of the dielectric layers 261 to 267. The plurality of through holes include particular through holes 61T2C and 61T2D formed in each of the dielectric layers 261 to 267. The particular through holes 60T2C and 60T2D formed in the dielectric layer 260 are connected respectively to the particular through holes 61T2C and 61T2D formed in the dielectric layer 261. In FIG. 40, each circle represents a through hole. In the dielectric layers 261 to 267, every vertically adjacent through holes are connected to each other.

The particular through holes 61T2C and 61T2D formed in the dielectric layer 267 are connected respectively to the conductor layers 681A and 681B formed on the patterned surface of the dielectric layer 168 (refer to FIG. 22). The plurality of through holes (excluding the particular through holes 61T2C and 61T2D) formed in the dielectric layer 267 are connected to the conductor layer 1681 formed on the patterned surface of the dielectric layer 168 (refer to FIG. 22).

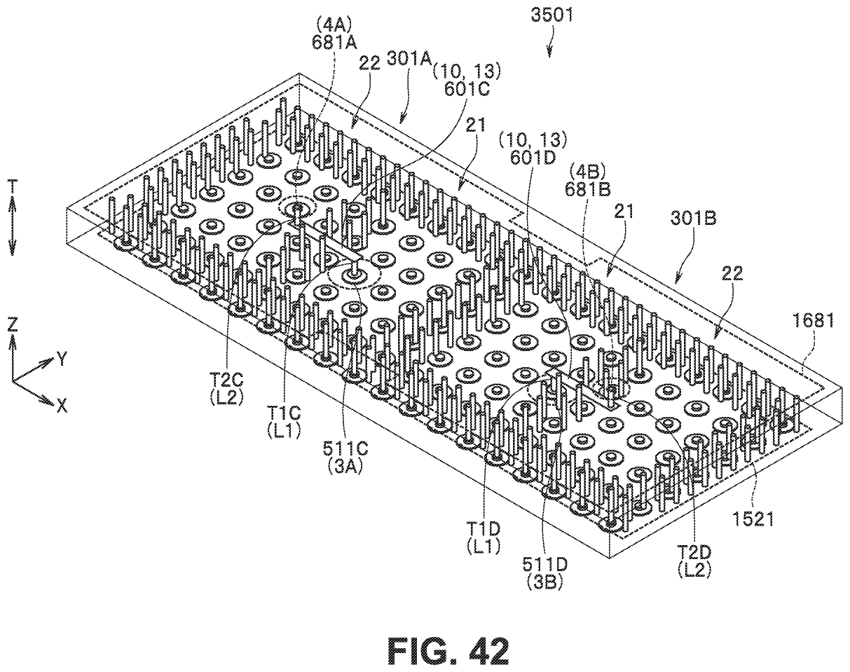

The main body 150 of the present embodiment is formed by stacking the first dielectric layer 151 (refer to FIG. 15), the second to seventeenth dielectric layers 252 to 267, and the eighteenth to fifty-fifth dielectric layers 168 to 205 (refer to FIG. 22 to FIG. 32). The main body 150 of the present embodiment includes a first portion 3501 instead of the first portion 1501 of the second embodiment. The first portion 3501 corresponds to a portion including the dielectric layers 151 and 252 to 267 of the main body 150. FIG. 42 illustrates the inside of the first portion 3501.

The line 13 of the first filter 301A is composed of the conductor layer 601C. The conductor layer 601C is connected to the conductor layer 511A constituting the first port 3A of the first filter 301A (refer to FIG. 15) via the particular through hole 51T1A (refer to FIG. 15), the conductor layer 521C, and the particular through holes 52T1C and 53T1C. The conductor layer 601C is connected to the conductor layer 681A constituting the second port 4A of the first filter 301A (refer to FIG. 22) via the particular through holes 60T2C and 61T2C.

In the first filter 301A, the conductor part L1 of the path 5 is composed of a through hole line T1C composed of the particular through holes 52T1C and 53T1C. The conductor part L2 of the path 5 is composed of a through hole line T2C composed of the particular through holes 60T2C and 61T2C.

The line 13 of the second filter 301B is composed of the conductor layer 601D. The conductor layer 601D is connected to the conductor layer 511B constituting the first port 3B of the second filter 301B (refer to FIG. 15) via the particular through hole 51T1B (refer to FIG. 15), the conductor layer 521D, and the particular through holes 52T1D and 53T1D. The conductor layer 601D is connected to the conductor layer 681B constituting the second port 4B of the second filter 301B (refer to FIG. 22) via the particular through holes 60T2D and 61T2C.

In the second filter 301B, the conductor part L1 of the path 5 is composed of a through hole line T1D composed of the particular through holes 52T1D and 53T1D. The conductor part L2 of the path 5 is composed of a through hole line T2D composed of the particular through holes 60T2D and 61T2D.

In the present embodiment, each of the first and second filters 301A and 301B functions as a band elimination filter.

The other configuration, function, and effects of the present embodiment are similar to those of the second embodiment.

Note that the present invention is not limited to the foregoing embodiments, and various modifications may be made thereto. For example, the number of cavity resonators may be one or may be three or more.

Obviously, many modifications and variations of the present invention are possible in the light of the above teachings. Thus, it is to be understood that, within the scope of the appended claims and equivalents thereof, the present invention may be practiced in other than the foregoing most preferable embodiments.

What is claimed is:

1. A filter comprising:
a first port;
a second port;
a path connecting the first port and the second port;
a circuit part provided in the path; and
at least one cavity resonator coupled with the path from an outside of the path in a circuit configuration.

2. The filter according to claim 1, wherein the at least one cavity resonator is composed of a conductor surrounding a three-dimensional region, and a dielectric present in the region.

3. The filter according to claim 1, wherein the at least one cavity resonator configures a band elimination filter.

4. The filter according to claim 1, wherein
the path includes a conductor part arranged in the at least one cavity resonator and extending in one direction,
the conductor part is located at a position shifted from a center of gravity of the at least one cavity resonator seen in one direction, and
the at least one cavity resonator is coupled with the conductor part.

5. The filter according to claim 1, wherein the at least one cavity resonator comprises a plurality of cavity resonators.

6. The filter according to claim 5, wherein the plurality of cavity resonators include a first cavity resonator coupled with the path between the first port and the circuit part, and a second cavity resonator coupled with the path between the second port and the circuit part.

7. The filter according to claim 1, wherein the circuit part is a band-pass filter.

8. The filter according to claim 1, wherein the circuit part is a line.

9. The filter according to claim 1, further comprising
a main body for integrating the first port, the second port, the path, the circuit part, and the at least one cavity resonator, wherein
the main body includes a first surface and a second surface facing opposite to each other.

10. The filter according to claim 9, wherein a size of the at least one cavity resonator in a direction perpendicular to the first surface is smaller than a size of the at least one cavity resonator in a direction parallel to the first surface.

11. The filter according to claim 9, wherein
the first port is arranged on the first surface, and
the second port is arranged at a position different from the first surface in the direction perpendicular to the first surface.

12. The filter according to claim 9, wherein the first port and the second port are arranged on the first surface.

13. An antenna composite component comprising:
the filter according to claim 1; and
an antenna connected to the second port.
